(19) United States
(12) Patent Application Publication
(10) Pub. No.: US 2018/0143552 A1
(43) Pub. Date: May 24, 2018

(54) ELECTROSTATIC CHARGE IMAGE DEVELOPING TONER, ELECTROSTATIC CHARGE IMAGE DEVELOPER, AND TONER CARTRIDGE

(71) Applicant: FUJI XEROX CO., LTD., Tokyo (JP)

(72) Inventors: Atsushi SUGAWARA, Kanagawa (JP); Kana YOSHIDA, Kanagawa (JP); Tsuyoshi MURAKAMI, Kanagawa (JP); Masaki IWASE, Kanagawa (JP)

(73) Assignee: FUJI XEROX CO., LTD., Tokyo (JP)

(21) Appl. No.: 15/592,265

(22) Filed: May 11, 2017

(30) Foreign Application Priority Data
Nov. 21, 2016 (JP) 2016-225868

(51) Int. Cl. G03G 9/09; G03G 9/087; G03G 9/08; G03G 15/08

(52) U.S. Cl. CPC G03G 9/0902; G03G 9/08755; G03G 9/08711; G03G 15/0865; G03G 9/0821; G03G 9/0819; G03G 9/0827; G03G 9/0804

(57) ABSTRACT

An electrostatic charge image developing toner includes a toner particle which contains a crystalline resin, an amorphous resin, and at least one of an inorganic pigment and a metallic pigment, wherein in differential scanning calorimetry, an endothermic peak Tm (° C.) derived from the crystalline resin in a first temperature rising process and an exothermic peak Tc (° C.) derived from the crystalline resin in a first temperature falling process after the first temperature rising process are present, and a relationship expressed by Tm>Tc is satisfied.

### CROSS-REFERENCE TO RELATED APPLICATIONS

This application is based on and claims priority under 35 USC 119 from Japanese Patent Application No. 2016-225868 filed Nov. 21, 2016.

### BACKGROUND

### 1. Technical Field

The present invention relates to an electrostatic charge image developing toner, an electrostatic charge image developer, and a toner cartridge.

### 2. Related Art

In recent years, in the forming of an image by an electrophotography method, in accordance with an increase in a demand for energy saving, a technique of fixing toner with lower energy and a toner capable of being fixed at a lower temperature are strongly required in order to reduce the amount of energy to be used at the time of fixing.

### SUMMARY

According to an aspect of the invention, there is provided an electrostatic charge image developing toner including:

a toner particle which contains a crystalline resin, an amorphous resin, and at least one of an inorganic pigment and a metallic pigment,

wherein, in differential scanning calorimetry, an endothermic peak Tm (° C.) derived from the crystalline resin in a first temperature rising process and an exothermic peak Tc (° C.) derived from the crystalline resin in a first temperature falling process after the first temperature rising process are present, and a relationship expressed by Tm>Tc is satisfied.

### BRIEF DESCRIPTION OF THE DRAWINGS

Exemplary embodiments of the present invention will be described in detail based on the following figures, wherein:

FIG. 1 is a configuration diagram illustrating an example of an image forming apparatus according to the exemplary embodiment; and

FIG. 2 is a configuration diagram illustrating an example of a process cartridge of the exemplary embodiment.

### DETAILED DESCRIPTION

Hereinafter, the exemplary embodiments of an electrostatic charge image developing toner, an electrostatic charge image developer, a toner cartridge, a process cartridge, an image forming apparatus, and an image forming method of the invention will be described in detail.

Electrostatic Charge Image Developing Toner

An electrostatic charge image developing toner (hereinafter, simply referred to as “toner” in some cases) according to the exemplary embodiment contains a toner particle which contains a crystalline resin, an amorphous resin, and at least one of an inorganic pigment and a metallic pigment, in which in differential scanning calorimetry, an endothermic peak Tm (° C.) derived from the crystalline resin in a first temperature rising process and an exothermic peak Tc (° C.) derived from the crystalline resin in a first temperature falling process after the first temperature rising process are present, and a relationship expressed by Tm>Tc is satisfied.

Note that, in a case where there are two or more of the exothermic peaks Tc, the relationship between Tm and the lowest Tc are required to satisfy Tm>Tc.

The toner according to the exemplary embodiment is excellent in the low-temperature fixability and has less stacking. Although the reason is not clear, the following reasons may be presumed.

Note that, “stacking” in the exemplary embodiment means a phenomenon in which the recording media after the toner image formation adhere to each other in a situation where recording media after the toner image formation are stacked in a state where the latent heat of the recording medium is high when the toner image are continuously formed.

In the toner according to the exemplary embodiment, the crystalline resin and the amorphous resin are used in combination, and thus a melting temperature of the crystalline resin is lowered due to the compatibility between both. For this reason, the low-temperature fixability of the toner is improved. On the other hand, when the melting temperature of the crystalline resin is lowered, the stacking is likely to occur in some cases.

Here, regarding the toner according to the exemplary embodiment, in the differential scanning calorimetry, the endothermic peak Tm (° C.) derived from the crystalline resin in the first temperature rising process and the exothermic peak Tc (° C.) derived from the crystalline resin in the first temperature falling process after the first temperature rising process are present, and the relationship expressed by Tm>Tc is satisfied. The fact that endothermic peak Tm and the exothermic peak Tc are present and satisfy the relationship expressed by Tm>Tc means that the toner image is fixed on a recording medium, and then recrystallization occurs on the crystalline resin during a cooling step. When the recrystallization of the crystalline resin occurs, the strength of the toner image which is fixed on the recording medium is enhanced. Therefore, in the toner according to the exemplary embodiment, it is presumed that the low-temperature fixability of the toner is improved, and the occurrence of the stacking is prevented.

Meanwhile, according to studies of the inventors, it is found that the exothermic peak Tc does not appear in the color toner in the related art in which an organic pigment is used. On the other hand, the reason for the appearance of the exothermic peak Tc in the toner according to the exemplary embodiment is presumed that at least one of the inorganic pigment and the metallic pigment is contained in the toner. The inorganic pigment and the metallic pigment have low specific heat as compared with the organic pigment used in the color toner in the related art. When the toner contains at least one of the inorganic pigment and the metallic pigment having low specific heat, the temperature of the inorganic pigment or the metallic pigment becomes higher at the time of adding the same amount of heat, and thus the temperature of the inside of the toner easily becomes higher. Therefore, the crystalline resin present in the vicinity of the inorganic pigment or the metallic pigment is cooled from a high temperature state, and thus is easily recrystallized. As a result, it is considered that the recrystallization of the crystalline resin is accelerated as compared with the color toner in the related art in which the organic pigment is used.

Regarding the toner according to the exemplary embodiment, the thermal properties of the endothermic peak Tm and the exothermic peak Tc are obtained by differential scanning calorimetry (DSC).

The thermal properties of the toner are obtained based on ASTM D3418-99 by the DSC. In the measurement, a differential scanning calorimeter (Product name: DSC-60A, manufactured by SHIMADZU CORPORATION) is used, melting temperatures of indium and zinc are used for correcting the temperature of an apparatus detection part, and heat of fusion of indium is used for correcting the amount of heat. The measurement is performed by using an aluminum pan for a measurement sample, and setting an empty pan for comparison.

Specifically, 8 mg of toner is set on a sample holder of DSC-60A, the temperature rise rate is set to be 10° C./min, then the first temperature rising (the first temperature rising process) is performed from 0° C. to 150° C., and this state is kept at 150° C. for five minutes. Then, a temperature falling rate is set to be −10° C./min, then cooling (the first temperature falling process) is performed down to 0° C., and the state is kept at 0° C. for five minutes.

The endothermic peak Tm is obtained from a peak indicated in a DSC chart, obtained during the first temperature rising process. The exothermic peak Tc is obtained by the peak indicated in the DSC chart, obtained during by the first temperature falling process. In addition, an absolute value of the endothermic quantity of the endothermic peak Tm and an absolute value of the exothermic quantity of the exothermic peak Tc are calculated from the peak indicated in the DSC chart, respectively.

Note that, in a case where the toner according to the exemplary embodiment contains a release agent as a certain component, not only the endothermic peak and the exothermic peak derived from the crystalline resin, but also the endothermic peak and the exothermic peak derived from the release agent may be indicated in the DSC chart. A method of distinguish whether the peak indicated in the DSC chart is derived from the crystalline resin or derived from the release agent is not particularly limited.

A method of identifying whether the peak indicated in the DSC chart is derived from the crystalline resin or derived from the release agent in the first temperature rising process is as follows, for example.

For example, the crystalline resin and the release agent are separated from each other by using a difference in solubility of the crystalline resin and the release agent with respect to a solvent, and the separated components are identified by NMR, mass spectrometry, GPC, and the like. Examples of the solvent include tetrahydrofuran, diethyl ether, acetone, and methyl ethyl ketone. In a case of using tetrahydrofuran, the crystalline resin tends to be easily dissolved in the tetrahydrofuran, whereas the release agent tends to be difficult to dissolve in the tetrahydrofuran. In addition, there is a method of distinguishing whether the peak indicated in the DSC chart in the first temperature rising process regarding the toner is the endothermic peak derived from the crystalline resin or endothermic peak derived from the release agent by obtaining the DSC chart regarding the respective identified components in the first temperature rising process and comparing the endothermic peak indicated in the obtained chart with the DSC chart in the first temperature rising process regarding the toner.

The method of identifying peak indicated in the DSC chart in the first temperature falling process is as follows, for example.

(i) A case where in the DSC chart in the first temperature rising process, the endothermic peak derived from the crystalline resin is indicated as a temperature equal to or lower than 8° C. as compared with the endothermic peak derived from the release agent

In this case, the temperature at a top of a mountain between the endothermic peak derived from the crystalline resin and the endothermic peak derived from the release agent in the DSC chart in the first temperature rising process regarding the toner is identified. Then, the first temperature rising is performed for the toner from 0° C. to the top of the mountain, and the temperature at the top of the mountain is kept for five minutes. Subsequently, the temperature falling rate is set to be −10° C./minute, and the temperature is decreased down to 0° C., thereby obtaining the DSC chart for this state. When the heating is performed up to the temperature of the top of the mountain of DSC chart in the first temperature rising process, the crystalline resin contained in the toner is dissolved; whereas the release agent is not dissolved. When the temperature falling is performed in this state, the exothermic peak derived from the crystalline resin is indicated in the DSC chart. From this chart, it is possible to identify the exothermic peak derived from the crystalline resin.

(ii) A case where in the DSC chart in the first temperature rising process, the difference between the endothermic peak derived from the crystalline resin and the endothermic peak derived from the release agent is less than 8° C.

As a unit that identifies the exothermic peak when the difference in the temperature of the endothermic peaks is close, the following unit may be exemplified; however, the unit is not limited to the following one.

Regarding the release agent and the crystalline resin in the toner, in order to compare the heating amounts of the endothermic peaks, the release agent is separated by using the difference in the solubility of the release agent and the binder resin with respect to the solvent. Then, after the release agent is separated, DSC measurement is performed on the toner components other than the release agent, and the heating amount of the endothermic peak of the crystalline resin is measured. At this time, the measurement is performed after heating the toner components other than the release agent at a temperature in a range of 5° C. to 10° C. higher than a glass transition temperature of the toner for one hour. Further, at the time of measuring the heating amount of the endothermic peak of the crystalline resin, the separation of the toner components other than the release agent is performed without changing the ratio thereof, or the calculation is performed in accordance with the composition ratio, in the measurement.

After that, the heating amount of the endothermic peak of the entire toner and the obtained heating amount of the endothermic peak of the crystalline resin are compared with each other so as to presume the heating amount of the endothermic peak derived from the release agent in the toner.

Next, the heating amount of the exothermic peak is confirmed by DSC chart in the temperature falling process of the toner by performing the DSC measurement. Here, in a case where the exothermic peak is divided into plural peaks, the heating amount of the endothermic peak and the heating amount of the exothermic peak are compared with each other, and a material having a close heating amount is identified as the crystalline resin or the release agent.

In a case where the exothermic peaks overlap, it is possible to identify that the exothermic peaks of the release agent and the crystalline resin are the same as each other. Further, in the above-described method, it is possible to measure the heating amount of the exothermic peak of the release agent by separating the release agent so as to measure the heating amount of the endothermic peak, and thus even when the exothermic peaks overlap, it is possible to presume the heating amount of the exothermic peak of the crystalline resin by subtracting the heating amount of the exothermic peak of the release agent.

In the exemplary embodiment, the difference between the endothermic peak Tm and the exothermic peak Tc is preferably from 2° C. to 20° C., is further preferably from 5° C. to 20° C., and is still further preferably from 10° C. to 20° C.

When the difference between the endothermic peak Tm and the exothermic peak Tc is from 2° C. to 20° C., the occurrence of the stacking is further prevented. In addition, when the difference between the endothermic peak Tm and the exothermic peak Tc is equal to or higher than 2° C., it means that the crystalline resin is disposed in the vicinity of the inorganic pigment or the metallic pigment, and thus there is an advantage of improving the stacking properties by the recrystallization of the crystalline resin. On the other hand, when the difference between the endothermic peak Tm and the exothermic peak Tc is equal to or lower than 20° C., it means the recrystallization of the crystalline resin occurs at a sufficiently high temperature, and thus there is an advantage of improving the stacking properties.

In the exemplary embodiment, it is preferable that the absolute value Qm of the endothermic quantity of the endothermic peak Tm and the absolute value Qc of the exothermic quantity of the exothermic peak Tc satisfy the relationship expressed by Qm>Qc. When the relationship expressed by Qm>Qc is satisfied, the occurrence of the stacking is further prevented.

When the absolute value Qm of the endothermic quantity is taken as 100, the ratio of the absolute value Qc of the exothermic quantity is preferably from 20 to 90, is further preferably from 30 to 90, and is still further preferably from 50 to 90.

The absolute value Qm of the endothermic quantity is preferably from 5 J/g to 30 J/g, is further preferably from 10 J/g to 30 J/g, and is still further preferably from 10 J/g to 20 J/g.

The absolute value Qc of the exothermic quantity is preferably from 4 J/g to 25 J/g, is further preferably from 10 J/g to 25 J/g, and is still further preferably from 10 J/g to 20 J/g.

In the exemplary embodiment, the exothermic peak Tc is preferably from 40° C. to 70° C., is further preferably from 45° C. to 70° C., and is still further preferably from 45° C. to 60° C.

When the exothermic peak Tc is from 40° C. to 70° C., there is an advantage of realizing both of the stacking properties and the low-temperature fixability. In addition, when the exothermic peak Tc is equal to or higher than 40° C., there is an advantage of improving the stacking properties, and thus the stacking is less likely to occur even after multiple printouts. On the other hand, when the exothermic peak Tc is equal to or lower than 70° C., the low-temperature fixability is further improved.

Note that, in a case where there are two or more exothermic peaks Tc, the lowest temperature of the exothermic peak Tc is preferably from 40° C. to 65° C., is further preferably from 45° C. to 65° C., and still further preferably from 45° C. to 60° C.

In the exemplary embodiment, the endothermic peak Tm is preferably from 45° C. to 75° C., is further preferably from 50° C. to 75° C., and is still further preferably from 55° C. to 75° C.

When the endothermic peak Tm is from 45° C. to 75° C., there is an advantage of realizing both of the low-temperature fixability and the toner storability. In addition, when the endothermic peak Tm is equal to or higher than 45° C., there is an advantage of improving the toner storability, and thus toner may be used under a high temperature even in summer season. On the other hand, when the endothermic peak Tm is equal to or lower than 75° C., there is an advantage that the low-temperature fixability is improved, which leads the toner to be fixed with less energy, and thus the toner may be used for a high speed machine.

Hereinafter, the toner according to the exemplary embodiment will be described in detail.

The toner according to the exemplary embodiment is configured to contain a toner particle, and as necessary, an external additive.

Toner Particle

A toner particle includes, for example, a binder resin, a coloring agent, and if necessary, a release agent, and other additives.

Binder Resin

Examples of the binder resin include vinyl resins formed of homopolymer of monomers such as styrenes (for example, styrene, para-chloro styrene, and α-methyl styrene), (meth)acrylic esters (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate), ethylenic unsaturated nitriles (for example, acrylonitrile, and methacrylonitrile), vinyl ethers (for example, vinyl methyl ether, and vinyl isobutyl ether), vinyl ketones (for example, vinyl methyl ketone, vinyl ethyl ketone, and vinyl isopropenyl ketone), and olefins (for example, ethylene, propylene, and butadiene), or copolymers obtained by combining two or more kinds of these monomers.

As the binder resin, there are also exemplified non-vinyl resins such as an epoxy resin, a polyester resin, a polyurethane resin, a polyamide resin, a cellulose resin, a polyether resin, and a modified rosin, a mixture thereof with the above-described vinyl resins, or a graft polymer obtained by polymerizing a vinyl monomer with the coexistence of such non-vinyl resins.

In the exemplary embodiment, an amorphous resin and a crystalline resin are used as the binder resin.

As the binder resin, the polyester resin is preferably used.

Examples of the polyester resin include a well-known amorphous polyester resin. As the polyester resin, the amorphous polyester resin and the crystalline polyester resin are used in combination. Note that, the content of the crystalline polyester resin may be from 2% by weight to 40% by weight (preferably from 2% by weight to 20% by weight) with respect to the entire binder resin.

Note that, “crystalline” of the resin means having a clear endothermic peak without endothermic change in a stepwise manner in the differential scanning calorimetry (DSC), and specifically, the half-value width of the endothermic peak is higher than 10° C. when measured at a heating rate of 10 (° C./min)

On the other hand, “amorphous” of the resin means that the half value width is higher than 10° C., the endothermic change is indicated in stepwise manner, or clear endothermic peak is not recognized.

Amorphous Polyester Resin

Examples of the amorphous polyester resin include condensation polymers of polyvalent carboxylic acids and polyol. A commercially available product or a synthesized product may be used as the amorphous polyester resin.

Examples of the polyvalent carboxylic acid include aliphatic dicarboxylic acid (for example, oxalic acid, malonic acid, maleic acid, fumaric acid, citraconic acid, itaconic acid, glutaconic acid, succinic acid, alkenyl succinic acid, adipic acid, and sebacic acid), alicyclic dicarboxylic acid (for example, cyclohexane dicarboxylic acid), aromatic dicarboxylic acid (for example, terephthalic acid, isophthalic acid, phthalic acid, and naphthalene dicarboxylic acid), an anhydride thereof, or lower alkyl esters (having, for example, from 1 to 5 carbon atoms) thereof. Among these, for example, aromatic dicarboxylic acids are preferably used as the polyvalent carboxylic acid.

As the polyvalent carboxylic acid, tri- or higher-valent carboxylic acid employing a crosslinked structure or a branched structure may be used in combination together with dicarboxylic acid. Examples of the tri- or higher-valent carboxylic acid include trimellitic acid, pyromellitic acid, anhydrides thereof, or lower alkyl esters (having, for example, 1 to 5 carbon atoms) thereof.

The polyvalent carboxylic acids may be used singly or in combination of two or more types thereof.

Examples of the polyol include aliphatic diol (for example, ethylene glycol, diethylene glycol, triethylene glycol, propylene glycol, butanediol, hexanediol, and neopentyl glycol), alicyclic diol (for example, cyclohexanediol, cyclohexane dimethanol, and hydrogenated bisphenol A), aromatic diol (for example, an ethylene oxide adduct of bisphenol A, and a propylene oxide adduct of bisphenol A). Among these, for example, aromatic diols and alicyclic diols are preferably used, and aromatic diols are further preferably used as the polyol.

As the polyol, a tri- or higher-valent polyol employing a crosslinked structure or a branched structure may be used in combination together with diol. Examples of the tri- or higher-valent polyol include glycerin, trimethylolpropane, and pentaerythritol.

The polyol may be used singly or in combination of two or more types thereof.

The glass transition temperature (Tg) of the amorphous polyester resin is preferably from 50° C. to 80° C., and is further preferably from 50° C. to 65° C.

The glass transition temperature is obtained from a DSC curve obtained by differential scanning calorimetry (DSC). More specifically, the glass transition temperature is obtained from “extrapolated glass transition onset temperature” described in the method of obtaining a glass transition temperature in JIS K 7121-1987 “testing methods for transition temperatures of plastics”.

The weight average molecular weight (Mw) of the amorphous polyester resin is preferably from 5,000 to 1,000,000, and is further preferably from 7,000 to 500,000.

The number average molecular weight (Mn) of the amorphous polyester resin is preferably from 2,000 to 100,000.

The molecular weight distribution Mw/Mn of the amorphous polyester resin is preferably from 1.5 to 100, and is further preferably from 2 to 60.

The weight average molecular weight and the number average molecular weight are measured by gel permeation chromatography (GPC). The molecular weight measurement by GPC is performed using GPC⋅HLC-8120 GPC, manufactured by Tosoh Corporation as a measuring device, Column TSK gel Super HM-M (15 cm), manufactured by Tosoh Corporation, and a THF solvent. The weight average molecular weight and the number average molecular weight are calculated by using a molecular weight calibration curve plotted from a monodisperse polystyrene standard sample from the results of the foregoing measurement.

A known preparing method is used to prepare the amorphous polyester resin. Specific examples thereof include a method of conducting a reaction at a polymerization temperature set to be in a range of 180° C. to 230° C., if necessary, under reduced pressure in the reaction system, while removing water or an alcohol generated during condensation.

When monomers of the raw materials are not dissolved or compatibilized under a reaction temperature, a high-boiling-point solvent may be added as a solubilizing agent to dissolve the monomers. In this case, a polycondensation reaction is conducted while distilling away the solubilizing agent. When a monomer having poor compatibility is present in the copolymerization reaction, the monomer having poor compatibility and an acid or an alcohol to be polycondensed with the monomer may be previously condensed and then polycondensed with the major component.

Crystalline Polyester Resin

Examples of the crystalline polyester resin include a polycondensate of polyvalent carboxylic acid and polyol. Note that, as the crystalline polyester resin, a commercially available product may be used or, synthesized product may be used.

Here, the crystalline polyester resin easily forms a crystalline structure, and thus a polycondensate obtained by using a polymerizable monomer having a linear aliphatic group rather than a polymerizable monomer having an aromatic group is preferable.

Examples of the polyvalent carboxylic acid include aliphatic dicarboxylic acid (for example, oxalic acid, succinic acid, glutaric acid, adipic acid, suberic acid, azelaic acid, sebacic acid, 1,9-nonanedicarboxylic acid, 1, 10-decanedicarboxylic acid, 1, 12-dodecanedicarboxylic acid, 1,14-tetradecanedicarboxylic acid, and 1,18-octadecanedicarboxylic acid), aromatic dicarboxylic acid (for example, phthalic acid, isophthalic acid, terephthalic acid, dibasic acid of naphthalene-2,6-dicarboxylic acid), anhydrides thereof, or lower alkyl esters (having, for example, from 1 to 5 carbon atoms) thereof.

As the polyvalent carboxylic acid, tri- or higher-valent carboxylic acid employing a crosslinked structure or a branched structure may be used in combination together with dicarboxylic acid. Examples of tri-valent carboxylic acid include aromatic carboxylic acids (for example, 1,2,3-benzenetricarboxylic acid, 1,2,4-benzenetricarboxylic acid, 1,2,4-naphthalenetricarboxylic acid), anhydrides thereof, or lower alkyl esters (having, for example, from 1 to 5 carbon atoms) thereof.

Examples of the polyvalent carboxylic acid include a dicarboxylic acid having a sulfonic acid group and dicarboxylic acid having an ethylenic double bond may be used together with these dicarboxylic acids.

The polyvalent carboxylic acids may be used singly or in combination of two or more types thereof.

Examples of the polyol include an aliphatic diol (for example, a linear aliphatic diol having a carbon number of 7 to 20 in the main chain portion). Examples of the aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,14-undecanediol, 1,12-dodecanediol, 1,13-tridecanediol, 1,14-tetradecanediol, 1,18-octadecanediol, and 1,14-eicosanedecanediol. Among them, examples of the aliphatic diol preferably include 1,8-octanediol, 1,9-nonanediol, and 1,10-decanediol.

As the polyol, a tri- or higher-valent polyol employing a crosslinked structure or a branched structure may be used in combination together with diol. Examples of the tri- or higher-valent polyol include glycerin, trimethylolethane, trimethylolpropane, and pentaerythritol.

The polyol may be used singly or in combination of two or more types thereof.

Here, polyol may have the aliphatic diol of which the content is preferably equal to or greater than 80 mol %, and further preferably equal to or greater than 90 mol %.

The melting temperature of the crystalline polyester resin is preferably from 45° C. to 75° C., is further preferably from 50° C. to 75° C., and is still further preferably from 55° C. to 75° C.

Note that, the melting temperature is obtained from a DSC curve obtained by differential scanning calorimetry (DSC), and specifically obtained from “melting peak temperature” described in the method of obtaining a melting temperature in JIS K 7121-1987 “testing methods for transition temperatures of plastics”.

The weight average molecular weight (Mw) of the crystalline polyester resin is preferably from 6,000 to 35,000.

Similar to the amorphous polyester resin, the crystalline polyester resin is obtained by using a well-known preparing method.

The content of the binder resin is preferably from 40% by weight to 95% by weight, is further preferably from 50% by weight to 90% by weight, and is still further preferably from 60% by weight to 85% by weight, with respect to the entire toner particles.

Coloring Agent

In the toner according to the exemplary embodiment, at least one of the inorganic pigment and the metallic pigment is used as a coloring agent.

Examples of the components of the metallic pigments used in the exemplary embodiment include metallic particles such as aluminum, brass, bronze, nickel, stainless steel, and zinc. As the metallic pigments used in the exemplary embodiment are preferably aluminum particles such that the toner according to the exemplary embodiment functions as a so-called brilliant toner. In addition, the occurrence of the stacking is further prevented by using the aluminum particles.

Examples of the components of the inorganic pigments used in the exemplary embodiment include titanium dioxide (titania), silica, alumina, calcium carbonate, aluminum hydroxide, satin white, talc, calcium sulfate, magnesium oxide, magnesium carbonate, white carbon, kaolin, aluminosilicate, sericite, bentonite, and smectite. As the inorganic pigments used in the exemplary embodiment is preferably titanium oxide particles such that the toner according to the exemplary embodiment functions as a so-called white toner. In addition, the occurrence of the stacking is further prevented by using the titanium oxide particles.

The shape of the particles of the metallic pigment and the inorganic pigment is not particularly limited, and may be flattened or the like.

The toner according to the exemplary embodiment may use other coloring agents in addition to the inorganic pigment and the metallic pigment. Examples of other coloring agents include an organic pigment, and an organic dye.

Examples of other coloring agents include various organic pigments such as carbon Black, chrome Yellow, Hansa Yellow, Benzidine Yellow, Threne Yellow, Quinoline Yellow, Pigment Yellow, Permanent Orange GTR, Pyrazolone Orange, Vulcan Orange, Watchung red, Permanent Red, Brilliant carmine 3B, Brilliant carmine 6B, Du Pont Oil Red, pyrazolone red, Lithol Red, Rhodamine B lake, Lake Red C, Pigment Red, Rose Bengal, Aniline Blue, Ultramarine Blue, Calco oil Blue, methylene Blue chloride, phthalocyanine Blue, Pigment Blue, phthalocyanine Green, and malachite Green oxalate, or various organic dyes such as an acridine dye, a xanthene dye, an azo dye, a benzoquinone dye, an azine dye, an anthraquinone dye, a thioindigo dye, a dioxazine dye, a thiazine dye, an azomethine dye, an indigo dye, a phthalocyanine dye, an aniline black dye, a polymethine dye, a triphenyl methane dye, a diphenyl methane dye, and a thiazole dye.

As the coloring agent, a coloring agent which is subjected to the surface treatment may be used or the coloring agent may be used in combination with a dispersion as necessary. In addition, plural coloring agents may be used in combination.

The content of the coloring agent is preferably from 1% by weight to 30% by weight, and is further preferably from 3% by weight to 15% by weight with respect to the entire toner particles.

Release Agent

Examples of the release agent include a hydrocarbon wax; a natural wax such as a carnauba wax, a rice wax, and a candelilla wax; a synthetic or mineral ⋅ petroleum wax such as a montan wax; an ester wax such as fatty acid ester and montan acid ester; and the like. However, the release agent is not limited thereto.

The melting temperature of the release agent is preferably from 50° C. to 110°, and is further preferably from 60° C. to 100° C.

Note that, the melting temperature is obtained from “melting peak temperature” described in the method of obtaining a melting temperature in JIS K 7121-1987 “testing methods for transition temperatures of plastics”, from a DSC curve obtained by differential scanning calorimetry (DSC).

The content of the release agent is preferably from 1% by weight to 20% by weight, and is further preferably from 5% by weight to 15% by weight, with respect to the entire toner particles.

Other Additives

Examples of other additives include known additives such as a magnetic material, a charge-controlling agent, and an inorganic powder. The toner particles contain these additives as internal additives.

Properties of Toner Particles

The toner particles may be toner particles having a single-layer structure, or toner particles having a so-called core ⋅ shell structure composed of a core (core particle) and a coating layer (shell layer) coated on the core.

Here, the toner particles having a core ⋅ shell structure is preferably composed of, for example, a core containing a binder resin, and if necessary, other additives such as a coloring agent and a release agent and a coating layer containing a binder resin.

The volume average particle diameter (D50v) of the toner particles is preferably from 2 μm to 15 μm, and is further preferably from 4 μm to 12 μm.

Various average particle diameters and various particle diameter distribution indices of the toner particles are measured using a COULTERMULTISIZER II (manufactured by Beckman Coulter, Inc.) and ISOTON-II (manufactured by Beckman Coulter, Inc.) as an electrolyte.

In the measurement, a measurement sample from 0.5 mg to 50 mg is added to 2 ml of a 5% aqueous solution of surfactant (preferably sodium alkylbenzene sulfonate) as a dispersing agent. The obtained material is added to the electrolyte from 100 ml to 150 ml.

The electrolyte in which the sample is suspended is subjected to a dispersion treatment using an ultrasonic disperser for 1 minute, and a particle diameter distribution of particles having a particle diameter of from 2 μm to 60 μm is measured by a Coulter Multisizer II using an aperture having an aperture diameter of 100 μm. 50,000 particles are sampled.

Cumulative distributions by volume and by number are drawn from the side of the smallest diameter with respect to particle diameter ranges (channels) separated based on the measured particle diameter distribution. The particle diameter when the cumulative percentage becomes 16% is identified as that corresponding to a volume average particle diameter D16v and a number average particle diameter D16p, while the particle diameter when the cumulative percentage becomes 50% is identified as that corresponding to a volume average particle diameter D50v and a number average particle diameter D50p. Furthermore, the particle diameter when the cumulative percentage becomes 84% is identified as that corresponding to a volume average particle diameter D84v and a number average particle diameter D84p.

Using these, a volume average particle diameter distribution index (GSDv) is calculated as (D84v/D16v)^{1/2}, while a number average particle diameter distribution index (GSDp) is calculated as (D84p/D16p)^{1/2}.

The average circularity of the toner particles is preferably from 0.94 to 1.00, and is preferably from 0.95 to 0.98.

The average circularity of the toner particles is calculated by (circumference length of circle equivalent diameter)/(circumference length) [(circumference length of circle having the same projection area as that of particle image)/(circumference length of particle projected image)]. Specifically, the value is measured by using the following method.

The average circularity of the toner particles is calculated by using a flow particle image analyzer (measured by FPIA-3000 manufactured by Sysmex Corporation) which first, suctions and collects the toner particles to be measured so as to form flat flow, then captures a particle image as a static image by instantaneously emitting strobe light, and then performs image analysis of the obtained particle image. 3,500 particles are sampled at the time of calculating the average circularity.

In a case where the toner contains an external additive, the toner (the developer) to be measured is dispersed in the water containing a surfactant, and then the water is subjected to an ultrasonic treatment so as to obtain the toner particles in which the external additive is removed.

External Additive

Examples of the external additive include inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)n, Al₂O₃.2SiO₂, CaCO₃, MgCO₃, BaSO₄, and MgSO₄.

Surfaces of the inorganic particles as an external additive are preferably treated with a hydrophobizing agent. The hydrophobizing treatment is performed by, for example, dipping the inorganic particles in a hydrophobizing agent. The hydrophobization treating agent is not particularly limited and examples thereof include a silane coupling agent, silicone oil, a titanate coupling agent, and an aluminum coupling agent. These may be used alone or in combination of two or more kinds thereof.

Generally, the amount of the hydrophobization treating agent is, for example, from 1 part by weight to 10 parts by weight with respect to 100 parts by weight of the inorganic particles.

Examples of the external additive include a resin particle (resin particle such as polystyrene, polymethyl methacrylate (PMMA), and melamine resin), a cleaning aid (for example, metal salts of higher fatty acids typified by zinc stearate, and particles having fluorine high molecular weight polymer).

The amount of the external additive is, for example, preferably from 0.01% by weight to 5% by weight, and is further preferably from 0.01% by weight to 2.0% by weight with respect to the toner particles.

Method of Preparing Toner

Next, the method of preparing the toner according to the exemplary embodiment will be described.

The toner according to the exemplary embodiment is obtained by additionally adding the external additive to the toner particles after preparing the toner particles.

The toner particles may be prepared by using any one of a drying method (for example, a kneading and pulverizing method) a wetting method (for example, an aggregation and coalescence method, a suspension polymerization method, and a dissolution suspension method). The preparing method of the toner particles is not particularly limited, and well-known method may be employed.

Among them, the toner particles may be obtained by using the aggregation and coalescence method.

Specifically, for example, in a case where the toner particles are prepared by using the aggregation and coalescence method, the toner particles are prepared through the steps. The steps include a step of preparing a resin particle dispersion in which resin particles corresponding to binder resins are dispersed (a resin particle dispersion preparing step), a step of forming aggregated particles by aggregating resin particles (other particles as necessary) in the resin particle dispersion (if necessary, in the dispersion mixed with other particle dispersions), (an aggregated particles forming step), and a step of coalescing aggregated particles by heating an aggregated particle dispersion in which aggregated particles are dispersed so as to form toner particles (a coalescence step).

Hereinafter, the respective steps will be described in detail.

In the following description, a method of obtaining toner particles including a release agent will be described. However, the release agent is used only if necessary. Other additives other than the release agent may also be used.

Resin Particle Dispersion Preparing Step

First, a resin particle dispersion in which the resin particles corresponding to the binder resins are dispersed, a coloring agent particle dispersion in which coloring agent particles are dispersed, and a release agent particle dispersion in which the release agent particles are dispersed are prepared, for example.

Here, the resin particle dispersion is, for example, prepared by dispersing the resin particles in a dispersion medium with a surfactant.

An aqueous medium is used, for example, as the dispersion medium used in the resin particle dispersion.

Examples of the aqueous medium include water such as distilled water, ion exchange water, or the like, alcohols, and the like. The medium may be used singly or in combination of two or more types thereof.

Examples of the surfactant include anionic surfactants such as sulfate, sulfonate, phosphate, and soap anionic surfactants; cationic surfactants such as amine salt and quaternary ammonium salt cationic surfactants; and nonionic surfactants such as polyethylene glycol, alkyl phenol ethylene oxide adduct, and polyol. Among them, anionic surfactants and cationic surfactants are particularly preferable. Nonionic surfactants may be used in combination with anionic surfactants or cationic surfactants.

The surfactants may be used singly or in combination of two or more types thereof.

Regarding the resin particle dispersion, as a method of dispersing the resin particles in the dispersion medium, a common dispersing method using, for example, a rotary shearing-type homogenizer, or a ball mill, a sand mill, or a Dyno mill as media is exemplified. Depending on the type of the resin particles, the resin particles may be dispersed in the resin particle dispersion using, for example, a phase inversion emulsification method.

The phase inversion emulsification method includes: dissolving a resin to be dispersed in a hydrophobic organic solvent in which the resin is soluble; conducting neutralization by adding a base to an organic continuous phase (O phase); and converting the resin (so-called phase inversion) from W/O to O/W by adding an aqueous medium (W phase) to form a discontinuous phase, thereby dispersing the resin as particles in the aqueous medium.

The volume average particle diameter of the resin particles dispersed in the resin particle dispersion is preferably from 0.01 μm to 1 μm, is further preferably from 0.08 μm to 0.8 μm, and is still further preferably from 0.1 μm to 0.6 μm, for example.

Note that, the volume average particle diameter of the resin particles in the resin particle dispersion of the crystalline resin is for example, preferably from 0.02 μm to 0.5 μm, and is further preferably from 0.08 μm to 0.3 μm. With this, the recrystallization of the crystalline resin contained in the toner particles is accelerated, and thus the heat resistance in the fixed image is improved, thereby easily preventing the stacking after fixation.

Regarding the volume average particle diameter of the resin particles, a cumulative distribution by volume is drawn from the side of the smallest diameter with respect to particle diameter ranges (channels) separated using the particle diameter distribution obtained by the measurement of a laser diffraction-type particle diameter distribution measuring device (for example, manufactured by Horiba, Ltd., LA-700), and a particle diameter when the cumulative percentage becomes 50% with respect to the entire particles is measured as a volume average particle diameter D50v. The volume average particle diameter of the particles in other dispersion liquids is also measured in the same manner.

The content of the resin particles contained in the resin particle dispersion is, for example, preferably from 5% by weight to 50% by weight, and further preferably from 10% by weight to 40% by weight.

For example, the coloring agent particle dispersion and the release agent particle dispersion are also prepared in the same manner as in the case of the resin particle dispersion. That is, the resin particles in the resin particle dispersion are the same as the coloring agent particles dispersed in the coloring agent particle dispersion and the release agent particles dispersed in the release agent particle dispersion, in terms of the volume average particle diameter, the dispersion medium, the dispersing method, and the content of the particles in the resin particle dispersion.

Aggregated Particle Forming Step

Next, the resin particle dispersion, the coloring agent particle dispersion, and the release agent particle dispersion are mixed with each other.

The resin particles, the coloring agent particles, and the release agent particle are heterogeneously aggregated in the mixed dispersion, thereby forming aggregated particles which have a diameter near a target toner particle diameter and include the resin particles, the coloring agent particles, and the release agent particles.

Specifically, for example, an aggregating agent is added to the mixed dispersion and a pH of the mixed dispersion is adjusted to be acidic (for example, the pH is from 2 to 5). If necessary, a dispersion stabilizer is added. Then, the mixed dispersion is heated at a temperature of a glass transition temperature of the resin particles (specifically, for example, in a range of (glass transition temperature of the resin particles−30° C.) to (glass transition temperature of the resin particles−10° C.) to aggregate the particles dispersed in the mixed dispersion, thereby forming a aggregated particle.

In the aggregated particle forming step, for example, the aggregating agent may be added at room temperature (for example, 25° C.) while stirring the mixed dispersion using a rotary shearing-type homogenizer, the pH of the mixed dispersion may be adjusted to be acidic (for example, the pH is from 2 to 5), a dispersion stabilizer may be added if necessary, and then the heating may be performed.

Examples of the aggregating agent include a surfactant having an opposite polarity to the polarity of the surfactant used as the dispersing agent to be added to the mixed dispersion, an inorganic metal salt, a divalent or more metal complex. Particularly, when a metal complex is used as the aggregating agent, the amount of the surfactant used is reduced and charging characteristics are improved.

An additive which forms a complex or a similar bond with metal ions of the aggregating agent may be used, if necessary. A chelating agent is suitably used as this additive.

Examples of the inorganic metal salt include metal salt such as calcium chloride, calcium nitrate, barium chloride, magnesium chloride, zinc chloride, aluminum chloride, and aluminum sulfate, and an inorganic metal salt polymer such as poly aluminum chloride, poly aluminum hydroxide, and calcium polysulfide.

As the chelating agent, an aqueous chelating agent may be used. Examples of the chelating agent include oxycarboxylic acid such as tartaric acid, citric acid, and gluconic acid, iminodiacetic acid (IDA), nitrilotriacetic acid (NTA), and ethylenediaminetetraacetic acid (EDTA).

The additive amount of the chelating agent is, for example, preferably from 0.01 parts by weight to 5.0 parts by weight, and is further preferably equal to or greater than 0.1 parts by weight and less than 3.0 parts by weight, with respect to 100 parts by weight of resin particles.

Further, from the aspect that the recrystallization is accelerated by disposing the crystalline resin in the vicinity of the coloring agent, a first aggregated particle described below may be formed by mixing and aggregating the coloring agent dispersion and the resin particle dispersion of the crystalline resin at first, and then, additionally mixing and aggregating the release agent particle dispersion and the resin particle dispersion of the amorphous resin.

Coalescence Step

Next, the aggregated particle dispersion in which the aggregated particles are dispersed is heated at, for example, a temperature that is equal to or higher than the glass transition temperature of the resin particles (for example, a temperature that is higher than the glass transition temperature of the resin particles by 10° C. to 30° C.) to perform the coalesce on the aggregated particles and form toner particles.

Further, from the aspect that the crystalline resin is disposed in the vicinity of the coloring agent by preventing domain growth of the crystalline resin, the heating temperature in the coalescence step may be set to be ±10° C. of the melting temperature of the crystalline resin.

The toner particles are obtained through the foregoing steps.

Note that, the toner particles may be obtained through a step of forming a second aggregated particle in such a manner that an aggregated particle dispersion in which the aggregated particles (first aggregated particle) are dispersed is obtained, the aggregated particle dispersion and the resin particle dispersion in which the resin particles are dispersed are mixed with each other, and aggregation is performed such that the resin particles are further attached on the surface of the aggregated particle, and a step of forming a toner particle having a core/shell structure by heating a second aggregated particle dispersion in which the second aggregated particles are dispersed, and coalescing the second aggregated particles.

Here, after completing the coalescence step, the toner particles formed in the solution are subjected to a washing step, a solid-liquid separation step, and a drying step, that are well known, and thus dry toner particles are obtained.

In the washing step, displacement washing using ion exchange water may be sufficiently performed from the viewpoint of charging properties. In addition, the solid-liquid separation step is not particularly limited, but suction filtration, pressure filtration, or the like is preferably performed from the viewpoint of productivity. The method of the drying step is also not particularly limited, but freeze drying, airflow drying, fluidized drying, vibration-type fluidized drying, or the like may be performed from the viewpoint of productivity.

The toner according to the exemplary embodiment is prepared by adding and mixing, for example, an external additive to the obtained dry toner particles. The mixing may be performed with, for example, a V-blender, a Henschel mixer, a Lodige mixer, or the like. Furthermore, if necessary, coarse particles of the toner may be removed by using a vibration sieving machine, a wind classifier, or the like.

Electrostatic Charge Image Developer

The electrostatic charge image developer in the exemplary embodiment includes at least the toner in the exemplary embodiment.

The electrostatic charge image developer in the exemplary embodiment may be a one-component developer including only the toner in the exemplary embodiment, or may be a two-component developer including the toner and a carrier.

The carrier is not particularly limited, and a well-known carrier may be used. Examples of the carrier include a coating carrier in which the surface of the core formed of magnetic particles is coated with the coating resin; a magnetic particle dispersion-type carrier in which the magnetic particles are dispersed and distributed in the matrix resin; and a resin impregnated-type carrier in which a resin is impregnated into the porous magnetic particles.

Note that, the magnetic particle dispersion-type carrier and the resin impregnated-type carrier may be a carrier in which the forming particle of the carrier is set as a core and the core is coated with the coating resin.

Examples of the magnetic particles include a magnetic metal such as iron, nickel, and cobalt, and a magnetic oxide such as ferrite, and magnetite.

Examples of the coating resin and the matrix resin include a straight silicone resin formed by containing polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene-acrylic acid ester copolymer, and an organosiloxane bond, or the modified products thereof, a fluororesin, polyester, polycarbonate, a phenol resin, and an epoxy resin.

Note that, other additives such as the conductive particles may be contained in the coating resin and the matrix resin.

Examples of the conductive particle include metal such as gold, silver, and copper, carbon black, titanium oxide, basic lead carbonate, tin oxide, barium sulfate, aluminum borate, and potassium titanate.

Here, in order to coat the surface of the core with the coating resin, a method of coating the surface with a coating layer forming solution in which the coating resin, and various additives if necessary are dissolved in a proper solvent is used. The solvent is not particularly limited as long as a solvent is selected in consideration of a coating resin to be used and coating suitability.

Specific examples of the resin coating method include a dipping method of dipping the core into the coating layer forming solution, a spray method of spraying the coating layer forming solution onto the surface of the core, a fluid-bed method of spraying the coating layer forming solution to the core in a state of being floated by the fluid air, and a kneader coating method of mixing the core of the carrier with the coating layer forming solution and removing a solvent in the kneader coater.

The mixing ratio (weight ratio) of the toner to the carrier in the two-component developer is preferably in a range of toner: carrier=1:100 to 30:100, and is further preferably in a range of 3:100 to 20:100.

Image Forming Apparatus and Image Forming Method

An image forming apparatus and an image forming method according to this exemplary embodiment will be described.

The image forming apparatus according to the exemplary embodiment is provided with an image holding member, a charging unit that charges the surface of the image holding member, an electrostatic charge image forming unit that forms an electrostatic charge image on the charged surface of the image holding member, a developing unit that accommodates an electrostatic charge image developer, and develops the electrostatic charge image formed on the surface of the image holding member as a toner image by using the electrostatic charge image developer, a transfer unit that transfers the toner image formed on the surface of the image holding member to a surface of a recording medium, and a fixing unit that fixes the toner image transferred onto the surface of the recording medium. In addition, the electrostatic charge image developer according to the exemplary embodiment is used as the electrostatic charge image developer.

In the image forming apparatus according to the exemplary embodiment, an image forming method (the image forming method according to the exemplary embodiment) including a step of charging a surface of an image holding member, a step of forming an electrostatic charge image on the charged surface of the image holding member, a step of developing an electrostatic charge image formed on the surface of the image holding member as a toner image with the electrostatic charge image developer according to the exemplary embodiment, a step of transferring the toner image formed on the surface of the image holding member to a surface of a recording medium, and a step of fixing the toner image transferred to the surface of the recording medium is performed.

As the image forming apparatus according to the exemplary embodiment, well-known image forming apparatuses such as an apparatus including a direct-transfer type apparatus that directly transfers the toner image formed on the surface of the image holding member to the recording medium; an intermediate transfer type apparatus that primarily transfers the toner image formed on the surface of the image holding member to a surface of an intermediate transfer member, and secondarily transfers the toner image transferred to the intermediate transfer member to the surface of the recording medium; an apparatus including a cleaning unit that cleans the surface of the image holding member before being charged and after transferring the toner image; and an apparatus including an erasing unit that erases charges by irradiating the surface of the image holding member with erasing light before being charged and after transferring the toner image.

In a case where the intermediate transfer type apparatus is used, the transfer unit is configured to include an intermediate transfer member on the surface of which the toner image is transferred, a primary transfer unit that primarily transfers the toner image formed on the surface of the image holding member to the surface of the intermediate transfer member, and a secondary transfer unit that secondarily transfers the toner image formed on the surface of the intermediate transfer member to the surface of the recording medium.

In the image forming apparatus according to the exemplary embodiment, for example, a unit including the developing unit may be a cartridge structure (process cartridge) detachable from the image forming apparatus. As a process cartridge, for example, a process cartridge including the developing unit accommodating the electrostatic charge image developer in the exemplary embodiment is preferably used.

Hereinafter, an example of the image forming apparatus of the exemplary embodiment will be described; however, the invention is not limited thereto. Note that, major portions shown in the drawing will be described, and others will not be described.

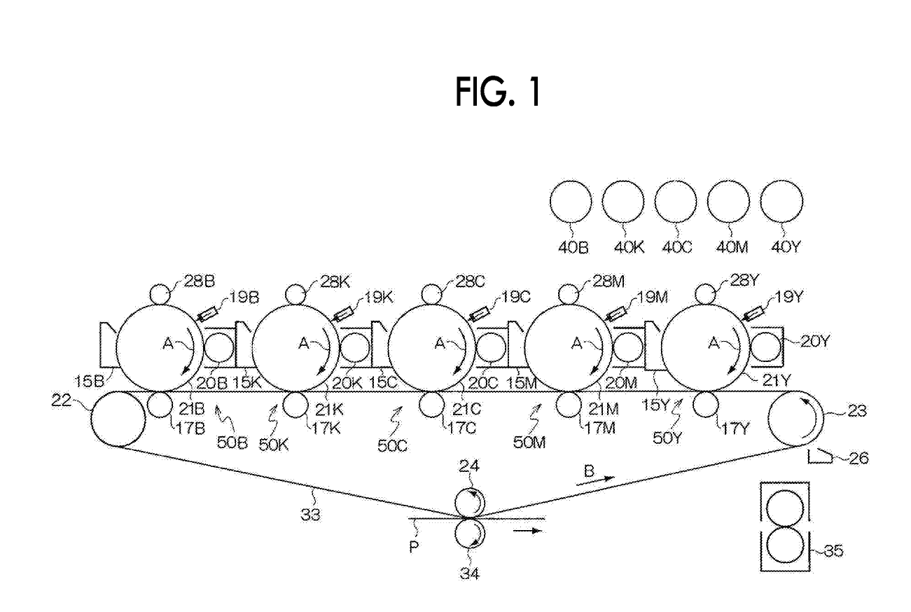

FIG. 1 is a configuration diagram illustrating an example of an image forming apparatus according to the exemplary embodiment. The image forming apparatus according to the exemplary embodiment relates to a tandem type configuration in which plural photoreceptors as an image holding member, that is, plural image forming units (image forming unit) are provided.

Note that, a case where a brilliant toner is used as the toner according to the exemplary embodiment will be described in the following description.

As illustrated in FIG. 1, in the image forming apparatus according to the exemplary embodiment, four image forming units 50Y, 50M, 50C, and 50K in which yellow, magenta, cyan, and black toner images are formed respectively, and an image forming unit 50B for forming a brilliant toner image are arranged in parallel (in tandem) at intervals. Note that, the respective image forming units are arranged in an order of the image forming units 50Y, 50M, 50C, 50K, and 50B from the upstream side of the rotation direction of an intermediate transfer belt 33.

Here, the respective image forming units 50Y, 50M, 50C, 50K, and 50B have the same configuration as each other except for toner color contained in the developer, and thus, the image forming unit 50Y for forming a yellow image will be described as a representative. Note that, the description of the respective image forming units 50M, 50C, 50K, and 50B will not be described by denoting reference numerals with magenta (M), cyan (C), black (K), and silver (B), instead of yellow (Y), to the same parts as the image forming unit 50Y.

When the yellow image forming unit 50Y is provided with a photoreceptor 21Y as an image holding member, the photoreceptor 21Y is rotated by a driving unit (not shown) at a predetermined process speed in a direction of arrow A in the drawings. As the photoreceptor 21Y, for example, an organic photoreceptor having sensitivity in an infrared region may be used.

A charging roller (charging unit) 28Y is provided on an upper portion of the photoreceptor 21Y, and a predetermined voltage by a power source (not shown) is applied to the charging roller 28Y such that the surface of the photoreceptor 21Y is charged to a predetermined potential.

In the vicinity of the photoreceptor 21Y, an exposure device (electrostatic charge image forming unit) 19Y which exposes the surface of the photoreceptor 21Y so as to form an electrostatic charge image is disposed on the downstream side of the rotation direction of the photoreceptor 21Y from the charging roller 28Y. Note that, in the exemplary embodiment, in terms of the space, LED arrays which realize miniaturization are used as the exposure device 19Y; however, the exposure device is not limited thereto. For example, an electrostatic charge image forming unit by other laser beams may be used.

In addition, in the vicinity of the photoreceptor 21Y, a developing device (developing unit) 20Y which is provided with a developer holding member for holding a yellow developer is disposed on the downstream side of the rotation direction of the photoreceptor 21Y from the exposure device 19Y, and the electrostatic charge image formed on the surface of the photoreceptor 21Y is developed by the yellow toner, and the toner image is formed on the surface of the photoreceptor 21Y.

On the lower side of the photoreceptor 21Y, an intermediate transfer belt (primary transfer unit) 33 which primarily transfers the toner image formed on the surface of the photoreceptor 21Y is disposed so as to across under the five photoreceptors 21Y, 21M, 21C, 21K, and 21B. The intermediate transfer belt 33 is pressed onto the surface of the photoreceptor 21Y by a primary transfer roller 17Y. In addition, the intermediate transfer belt 33 is stretched by three rollers of a driving roller 22, a supporting roller 23, and a bias roller 24, and is moved in the direction of an arrow B at a moving speed equivalent to the process speed of the photoreceptor 21Y. The yellow toner image is primarily transferred to the surface of the intermediate transfer belt 33, and the respective color toner images of the respective colors of yellow, magenta, cyan, black, and silver (brilliance) are primarily transferred and stacked in order.

In addition, in the vicinity of the photoreceptor 21Y, a cleaning device 15Y for cleaning the toner or re-transferred toner remaining on the surface of the photoreceptor 21Y is disposed on the downstream side of the rotation direction (direction of arrow A) of the photoreceptor 21Y from the primary transfer roller 17Y. A cleaning blade in the cleaning device 15Y is attached on the surface of the photoreceptor 21Y so as to be pressed in the counter direction.

a secondary transfer roller (secondary transfer unit) 34 is pressed to the bias roller 24 stretching the intermediate transfer belt 33 via the intermediate transfer belt 33. The toner images which are primarily transferred and stacked on the surface of the intermediate transfer belt 33 are electrostatically transferred to the surface of a recording sheet (recording medium) P supplied from a paper cassette (not shown) in a nip portion between the bias roller 24 and the secondary transfer roller 34. In this case, a silver toner image is a top (upper most layer) of the toner images which are transferred and stacked on the intermediate transfer belt 33, and thus in the toner images transferred to the surface of the recording sheet P, a silver toner image is a bottom (lower most layer).

In addition, a fixing device (fixing unit) 35 which fixes the toner images, which are transferred on the recording sheet P in a multiplexed manner, on the surface of the recording sheet P with heat and pressure so as to form a permanent image is disposed on the downstream of the secondary transfer roller 34.

Note that, examples of the fixing device 35 include a fixing belt having a belt shape, and a surface formed of a low surface energy material such as a fluororesin component and a silicone resin, and a cylindrical fixing roller having a surface formed of a low surface energy material such as a fluororesin component and a silicone resin.

Next, the operations of the respective image forming units 50Y, 50M, 50C, 50K, and 50B for forming images of the respective colors of yellow, magenta, cyan, black, and silver (brilliance). The operations of the respective image forming units 50Y, 50M, 50C, 50K, and 50B are the same as each other, and thus the operation of the yellow image forming unit 50Y will be described as a representative.

In the yellow developing unit 50Y, the photoreceptor 21Y is rotated at a predetermined process speed in a direction of arrow A. The surface of the photoreceptor 21Y is negatively charged to a predetermined potential by the charging roller 28Y. After that, the surface of the photoreceptor 21Y is exposed by the exposure device 19Y so as to form an electrostatic charge image in accordance with the image information. Subsequently, the toner which is negatively charged is reversely developed by the developing device 20Y, and the electrostatic charge image formed on the surface of the photoreceptor 21Y is visualized on the surface of the photoreceptor 21Y, thereby forming a toner image. After that, the toner image of the surface of the photoreceptor 21Y is primarily transferred to the surface of the intermediate transfer belt 33 by the primary transfer roller 17Y. After the primary transfer, transfer residual components such as toner on the surface of the photoreceptor 21Y are cleaned by being scratched with the cleaning blade of the cleaning device 15Y. The process proceeds to the next image forming step.

The above-described operations are performed in the respective image forming units 50Y, 50M, 50C, 50K, and 50B, and the toner images visualized on the surfaces of the respective photoreceptors 21Y, 21M, 21C, 21K, and 21B are transferred in a multiplexed manner to the surface of the intermediate transfer belt 33. In a color mode, the toner images of the respective colors are transferred in a multiplexed manner in order of yellow, magenta, cyan, black, and silver (brilliance); on the other hand in a two-color or three-color mode, only the toner image of the required color is transferred singly or transferred in a multiplexed manner in this order. After that, the toner images which are transferred singly or transferred in a multiplexed manner to the surface of the intermediate transfer belt 33 are secondarily transferred to the surface of the recording sheet P transported from a paper cassette (not shown) by the secondary transfer roller 34, and then are heated and pressurized to be fixed in the fixing device 35. After the secondary transfer, the toner remaining on the surface of the intermediate transfer belt 33 is cleaned by belt cleaner 26 formed of a cleaning blade for the intermediate transfer belt 33.

Toner Cartridge

Next, a toner cartridge according to the exemplary embodiment will be described.

The toner cartridge according to the exemplary embodiment contains the toner according to the exemplary embodiment, and is detachable from the image forming apparatus. The toner cartridge is used for containing replenishment toner which is to be supplied to the developing unit provided in the image forming apparatus.

In FIG. 1, toner cartridges 40Y, 40M, 40C, 40K, and 40B which contain toners of respective colors, and are connected to the developing device corresponding to each color with a toner supply tube (not shown). In addition, the toner cartridges 40Y, 40M, 40C, 40K, and 40B are detachable from the image forming apparatus, and when the toner contained in the toner cartridge runs low, the toner cartridge is replaced.

Process Cartridge

A process cartridge according to the exemplary embodiment will be described.

The process cartridge according to the exemplary embodiment is provided with a developing unit that accommodates the electrostatic charge image developer according to the exemplary embodiment and develops an electrostatic charge image formed on a surface of an image holding member with the electrostatic charge image developer to form a toner image, and is detachable from an image forming apparatus.

The process cartridge according to the exemplary embodiment is not limited to the above-described configuration, and may be configured to include a developing device, and as necessary, at least one selected from other units such as an image holding member, a charging unit, an electrostatic charge image forming unit, and a transfer unit.

Hereinafter, an example for the process cartridge according to the exemplary embodiment will be described, but the process cartridge is not limited thereto. Note that major portions shown in the drawing will be described, and others will not be described.

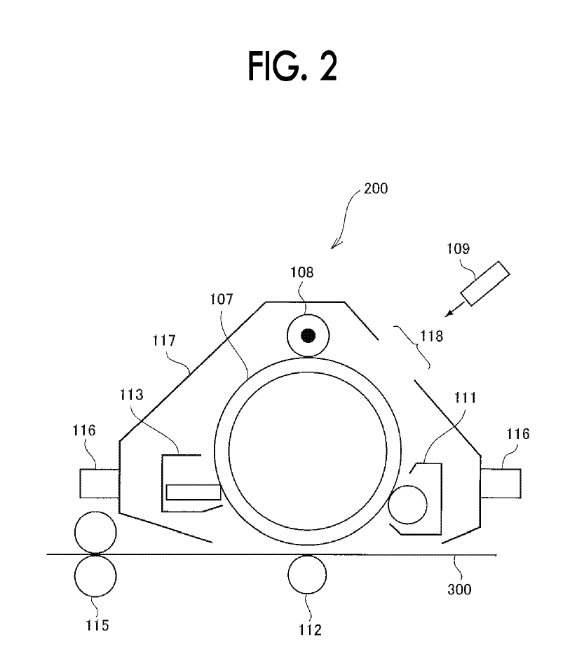

FIG. 2 is a configuration diagram illustrating the process cartridge according to this exemplary embodiment.

The process cartridge 200 illustrated in FIG. 2 is configured such that a photoreceptor 107 (an example of the image holding member), a charging roller 108 (an example of the charging unit) which is provided in the vicinity of the photoreceptor 107, a developing device 111 (an example of the developing unit), and a photoreceptor cleaning device 113 (an example of the cleaning unit) are integrally formed in combination, and are held by a housing 117 which is provided with an attached rail 116 and an opening portion 118 for exposing light so as to be a form of cartridge.

Note that, in FIG. 2, reference numeral 109 is denoted as an exposure device (an example of the electrostatic charge image forming unit), reference numeral 112 is denoted as a transfer device (an example of the transfer unit), reference numeral 115 is denoted as a fixing device (an example of the fixing unit), and reference numeral 300 is denoted as a recording sheet (an example of the recording medium).

### EXAMPLES

Hereinafter, the exemplary embodiment will be described in detail with reference to Examples and Comparative Examples, but is not limited thereto.

In the following description, unless specifically noted, “parts” and “%” are based on the weight.

Preparation of Metallic Pigment Dispersion
Aluminum pigment (2173EA, prepared by Showa Aluminum Corporation): 100 parts
Anionic surfactant (NEOGEN R prepared by Daiichi Kogyo Seiyaku Co., Ltd.): 1.5 parts
Ion exchange water: 400 parts

After a solvent is removed from a paste of the aluminum pigment, the pigment is mechanically pulverized by using a STAR MILL (LMZ, manufactured by Ashizawa Finetech Ltd.) so as to classify the metallic pigment in a range of 8 μm to 10 μm. After that, the surfactant and ion exchange water are mixed, and are dispersed with an emulsifying disperser CAVITRON (CR1010, manufactured by Pacific Machinery & Engineering Co., Ltd.) for one hour so as to prepare a metallic pigment dispersion (solid concentration: 20%) in which metallic pigment particles (aluminum pigments) are dispersed. The volume average particle diameter of the metallic pigment particles is 9.0 μm.

Preparation of Titanium White Pigment Dispersion
Titanium oxide (CR-60-2, prepared by Ishihara Sangyo Kaisha, Ltd.): 100 parts
Nonionic surfactant (product name: NONIPOLE 400 prepared by Sanyo Chemical Industries, Ltd.): 10 parts
Ion exchange water: 400 parts

The above-described components are mixed, stirred for 30 minutes by using a homogenizer (ULTRA-TURRAX T50, manufactured by IKA Ltd.), and then the mixture is dispersed for one hour by using a high pressure impact type dispersing machine ULTIMIZER (HJP30006: manufactured by Sugino Machine Limited Co., Ltd.) so as to prepare a titanium white pigment dispersion (solid concentration: 20%) in which the titanium white pigment particles having the volume average particle diameter of 210 nm are dispersed.

Preparation of Lead White Pigment Dispersion
Basic lead carbonate (prepared by Wako Pure Chemical Industries, Ltd.): 100 parts
Nonionic surfactant (product name: NONIPOLE 400 prepared by Sanyo Chemical Industries, Ltd.): 10 parts
Ion exchange water: 400 parts

The above-described components are mixed, stirred for 30 minutes by using a homogenizer (ULTRA-TURRAX T50, manufactured by IKA Ltd.), and then the mixture is dispersed for one hour by using a high pressure impact type dispersing machine ULTIMIZER (HJP30006: manufactured by Sugino Machine Limited Co., Ltd.) so as to prepare a lead white pigment dispersion (solid concentration: 20%) in which the lead white pigment particles having the volume average particle diameter of 280 nm are dispersed.

Preparation of Cobalt Blue Pigment Dispersion
Cobalt blue (Pigment Blue 28: prepared by Asahi Kasei Kogyo Co., Ltd.): 100 parts
Nonionic surfactant (product name: NONIPOLE 400 prepared by Sanyo Chemical Industries, Ltd.): 10 parts
Ion exchange water: 400 parts

The above-described components are mixed, stirred for 30 minutes by using a homogenizer (ULTRA-TURRAX T50, manufactured by IKA Ltd.), and then the mixture is dispersed for one hour by using a high pressure impact type dispersing machine ULTIMIZER (HJP30006: manufactured by Sugino Machine Limited Co., Ltd.) so as to prepare a cobalt blue pigment dispersion (solid concentration: 20%) in which inorganic blue pigments having the volume average particle diameter of 250 nm are dispersed.

Preparation of Cyan Coloring Agent Dispersion
C.I. Pigment Blue 15:3 (phthalocyanine type pigment, prepared by Dainichiseika Color & Chemicals, Cyanine Blue 4937): 50 parts
Anionic surfactant (NEOGEN RK manufactured by Daiichi Kogyo Seiyaku Co., Ltd.): 5 parts
Ion exchange water: 192.9 parts

The above-described components are mixed, are dispersed at 240 MPa for 10 minutes by using ULTIMIZER (manufactured by Sugino Machine Limited Co., Ltd.) so as to prepare a cyan coloring agent dispersion (solid concentration: 20%).

Preparation of Release Agent Dispersion
Polyethylene wax (prepared by Toyo Adl Corporation, PW655, melting temperature: 97° C.): 50 parts
Anionic surfactant (NEOGEN RK manufactured by Daiichi Kogyo Seiyaku Co., Ltd.): 1.0 parts
Sodium chloride (prepared by Wako Pure Chemical Industries, Ltd.): 5 parts
Ion exchange water: 200 parts

The above-described materials are mixed with each other, the mixture is heated at 95° C., is dispersed by using a homogenizer (ULTRA-TURRAX T50, manufactured by IKA Ltd.), and then is subjected to a dispersing treatment for 360 minutes by using Manton-Gaulin high pressure homogenizer (manufactured by Manton Gaulin Mfg Company Inc), thereby obtaining a release agent dispersion (solid concentration: 20%) in which release agents having a volume average particle diameter of 0.23 μm are dispersed.

Synthesis of Amorphous Polyester Resin
Bisphenol A ethylene oxide 2.2 mol adduct: 40% by mol
Bisphenol A propylene oxide 2.2 mol adduct: 60% by mol
Terephthalic acid: 47% by mol
Fumaric acid: 40% by mol
Dodecenyl succinic anhydride: 15% by mol
Trimellitic anhydride: 3% by mol

0.25 parts of the components other than fumaric acid and trimellitic anhydride among the above-described monomer components, and tin dioctanoate are put into a reaction vessel which is equipped with a stirrer, a thermometer, a condenser, and a nitrogen-introducing tube with respect to the total of 100 parts of the above-described monomer components. The mixture is reacted at 235° C. for six hours under nitrogen gas flow, and the temperature is decreased down to 200° C., and fumaric acid and trimellitic anhydride are put into the mixture and the reaction is performed for one hour. The temperature is further increased up to 220° C. over four hours, and the mixture is polymerized under the pressure of 10 kPa until a desired molecular weight is obtained, and thus, a light yellow transparent amorphous polyester resin is obtained.

The obtained amorphous polyester resin has a glass transition temperature Tg of 59° C. based on DSC, the weight average molecular weight Mw of 25,000 and the number average molecular weight Mn of 7,000 based on GPC, and a softening temperature of 107° C. based on flow tester, and an acid value AV of 13 mgKOH/g.

Preparation of Amorphous Polyester Resin Dispersion

While maintaining a jacketed 3-liter reaction vessel (BJ-30N manufactured by Tokyo Rikakikai Co., Ltd.) which is equipped with a condenser, a thermometer, a water dripping device, and an anchor blade at 40° C. in a thermostat circulating water bath, a mixed solvent obtained by mixing 160 parts of acetic acid ethyl and 100 parts of isopropyl alcohol is put into the reaction vessel, then 300 parts of the amorphous polyester resin is added thereinto, the mixture is stirred at 150 rpm by using a three-one motor and then the stirred mixture is dissolved, thereby obtaining an oil phase. 14 parts of 10% aqueous ammonia solution is added dropwise to the oil phase which is being stirred for five minutes, the resultant is mixed for 10 minutes, and then 900 parts of the ion exchange water is added dropwise to the mixture at a speed of 7 parts for every minute so as to perform phase inversion, thereby obtaining an emulsion.

Subsequently, 800 parts of the obtained emulsion and 700 parts of the ion exchange water are added into a 2-liter round-bottom flask, and the mixture is set in an evaporator (manufactured by Tokyo Rikakikai Co., Ltd.) which is provided with a vacuum control unit via a trap. The round-bottom flask is heated in a hot bath at 60° C. while being rotated, and a solvent is removed by reducing the pressure to 7 kPa with attention to bumping up the hot bath. The dispersion is obtained by returning the pressure to be a normal pressure, and cooling the round-bottom flask with water when a recovery amount of solvents becomes 1,100 parts. The obtained dispersion has no smell of solvent. The volume average particle diameter D50 of the resin particle in the dispersion is 130 nm.

After that, ion exchange water is added so as to adjust the solid concentration to be 20%, and the obtained liquid is set as an amorphous polyester resin dispersion.

Synthesis of Crystalline Polyester Resin (1)
1,10-dodecanedioic acid: 50% by mol
1,9-nonanediol: 50% by mol

The above-described monomer components are put into a reaction vessel which is equipped with a stirrer, a thermometer, a condenser, and a nitrogen-introducing tube, the inside of the reaction vessel is replaced with a dry nitrogen gas, and then 0.25 parts of titanium tetrabutoxide (reagent) is put into the reaction vessel with respect to 100 parts of the monomer components. Under nitrogen gas flow, the stirring reaction is performed at 170° C. for three hours, then the temperature is further increased up to 210° C. over one hour, the inside of the reaction vessel is depressurized to 3 kPa, and then the stirring reaction is performed for 13 hours under reduced pressure, thereby obtaining a crystalline polyester resin (1).

The obtained crystalline polyester resin (1) has a melting temperature of 74° C. based on DSC, a weight average molecular weight Mw of 25,000 and a number average molecular weight Mn of 10,500 based on GPC, and an acid value AV of 10.1 mgKOH/g.

Preparation of Crystalline Polyester Resin Dispersion (1)

While maintaining a jacketed 3-liter reaction vessel (BJ-30N manufactured by Tokyo Rikakikai Co., Ltd.) which is equipped with a condenser, a thermometer, a water dripping device, and an anchor blade at 70° C. in a thermostat circulating water bath, 300 parts of crystalline polyester resin (1), 160 parts of methyl ethyl ketone (solvent), and 100 parts of isopropyl alcohol (solvent) are put into the reaction vessel, and then are stirred and mixed at 100 rpm so as to dissolve the resin.

Then, the stirring rotation speed is set to be 150 rpm, the temperature of the thermostat circulating water bath is set to be 66° C., 17 parts of 10% ammonia water (reagent) are put into the reaction vessel over 10 minutes, and then 900 parts of the ion exchange water kept at 66° C. is added dropwise to the mixture at a speed of 7 parts for every minute so as to perform phase inversion, thereby obtaining an emulsion.

Subsequently, 800 parts of the obtained emulsion and 700 parts of the ion exchange water are added into a 2-liter round-bottom flask, and the mixture is set in an evaporator (manufactured by Tokyo Rikakikai Co., Ltd.) which is provided with a vacuum control unit via a trap. The round-bottom flask is heated in a hot bath at 6° C. while being rotated, and a solvent is removed by reducing the pressure to 7 kPa with attention to bumping up the hot bath. The dispersion is obtained by returning the pressure to be a normal pressure, and cooling the round-bottom flask with water when a recovery amount of solvents becomes 1,100 parts. The obtained dispersion has no smell of solvent. The volume average particle diameter of the resin particle in the dispersion is 130 nm. After that, ion exchange water is added so as to adjust the solid concentration to be 20%, and the obtained liquid is set as a crystalline polyester resin dispersion (1).

Synthesis of Crystalline Polyester Resin (2)

A crystalline polyester resin (2) is obtained in the same manner as in the synthesis of crystalline polyester resin (1) except that 1,10-dodecanedioic acid used in the crystalline polyester resin (1) is changed to dimethyl terephthalate.

The obtained crystalline polyester resin (2) has the melting temperature of 55° C. based on DSC, the weight average molecular weight Mw of 24,000 and the number average molecular weight Mn of 10,000 based on GPC, and an acid value AV of 11.0 mgKOH/g.

Preparation of Crystalline Polyester Resin Dispersion (2)

The same method as that used in the preparation of crystalline polyester resin dispersion (1) is performed except that the crystalline polyester resin (2) is used.

The volume average particle diameter of the resin particle in the dispersion is 130 nm. After that, ion exchange water is added so as to adjust the solid concentration to be 20%, and the obtained liquid is set as a crystalline polyester resin dispersion (2).

Synthesis of Crystalline Polyester Resin (3)

A crystalline polyester resin (3) is obtained in the same manner as in the synthesis of crystalline polyester resin (1) except that 1,10-dodecanedioic acid used in the crystalline polyester resin (1) is changed to fumaric acid, and 1,9-nonanediol is changed to 1,10-Decanediol.

The obtained crystalline polyester resin (3) has the melting temperature of 91° C. based on DSC, the weight average molecular weight Mw of 31,000 and the number average molecular weight Mn of 9,000 based on GPC, and an acid value AV of 11.2 mgKOH/g.

Preparation of Crystalline Polyester Resin Dispersion (3)

The same method as that used in the preparation of crystalline polyester resin dispersion (1) is performed except that the crystalline polyester resin (3) is used.

The volume average particle diameter of the resin particle in the dispersion is 150 nm. After that, ion exchange water is added so as to adjust the solid concentration to be 20%, and the obtained liquid is set as a crystalline polyester resin dispersion (3).

Preparation of Crystalline Styrene Acrylic Resin Dispersion
Styrene: 100 parts
Vinyl stearate: 208 parts
n-butyl acrylate: 100 parts
Acrylic acid: 4 parts
dodecanethiol: 6 parts
Propanediol diacrylate: 1.5 parts

The above-described components are mixed with each other, the dissolved mixture is put into an aqueous solution in which 4 parts of anionic surfactant (NEOGEN SC prepared by Daiichi Kogyo Seiyaku Co., Ltd.) is dissolved in 550 parts of ion exchange water, is emulsified in a flask, then an aqueous solution in which 6 parts of ammonium persulfate is dissolved in 50 parts of ion exchange water is put into the flask while mixing the mixture for 10 minutes, the inside of the flask is replaced with a nitrogen gas, the mixture is heated in an oil bath until the temperature of the content reaches 75° C. while stirring the inside of the flask, and the emulsion polymerization is continued for five hours in this state. In this way, a crystalline styrene acrylic resin dispersion (resin particle density: 40%) in which the resin particles having the average particle diameter of 190 nm, the weight average molecular weight (Mw) of 35000 are dispersed is obtained. Note that, the melting temperature of the crystalline styrene acrylic resin is 62° C.

Preparation of Amorphous Styrene Acrylic Resin Dispersion
Styrene: 308 parts
n-butyl acrylate: 100 parts
Acrylic acid: 4 parts
Dodecanethiol: 6 parts
Propanediol diacrylate: 1.5 parts

The above-described components are mixed with each other, the dissolved mixture is put into an aqueous solution in which 4 parts of anionic surfactant (NEOGEN SC prepared by Daiichi Kogyo Seiyaku Co., Ltd.) is dissolved in 550 parts of ion exchange water, is emulsified in a flask, then an aqueous solution in which 6 parts of ammonium persulfate is dissolved in 50 parts of ion exchange water is put into the flask while mixing the mixture for 10 minutes, the inside of the flask is replaced with a nitrogen gas, the mixture is heated in an oil bath until the temperature of the content reaches 75° C. while stirring the inside of the flask, and the emulsion polymerization is continued for five hours in this state. In this way, an amorphous styrene acrylic resin dispersion (resin particle density: 40%) in which the resin particles having the average particle diameter of 195 nm, the weight average molecular weight (Mw) of 34,000 are dispersed is obtained. Note that, the glass transition temperature of the amorphous styrene acrylic resin is 52° C.

### Example 1

Preparation of Toner Particle

50 parts of crystalline polyester resin dispersion (1), 50 parts of metallic pigment dispersion, and 4 parts of anionic surfactant (Tayca Power, prepared by Tayca Corporation) are put into a round stainless steel flask, 0.1 N of nitric acid is added to the flask, the pH is adjusted to 4.0, and then 0.3 parts of nitric acid aqueous solution having 10% of concentration of polyaluminum chloride is added to the flask. Subsequently, the resultant is dispersed at 30° C. for five minutes by using a homogenizer (ULTRA-TURRAX T50, manufactured by IKA Ltd.).

Subsequently, 400 parts of amorphous polyester resin dispersion, 50 parts of crystalline polyester resin dispersion (1), 150 parts of metallic pigment dispersion, and 70 parts of release agent dispersion are added to the dispersed slurry, 0.1 N of nitric acid is further added thereto, the pH of the mixture is adjusted to be 4.0, then 2.7 parts of nitric acid aqueous solution having 10% of concentration of polyaluminum chloride is added to the mixture, the mixture is dispersed at 30° C. for five minutes by using a homogenizer, and then the resultant is heated up to 45° C. in an oil bath for heating and kept for 30 minutes. After that, 230 parts of amorphous polyester resin dispersion is added to the obtained resultant and kept for one hour, 0.1 N aqueous sodium hydroxide solution is added thereto, the pH is adjusted to be 8.5, and then the resultant is heated up to 73° C. (in the vicinity of the melting temperature of the crystalline resin) while continuously stirring, and kept for five hours. Then, the resultant is cooled down to 20° C. at a rate of 20° C./min, filtrated, sufficiently washed by ion exchange water, and dried, thereby obtaining a toner particle (1) having a volume average particle diameter of 12 μm.

Preparation of Toner

100 parts of the toner particle (1) and 0.7 parts of dimethyl silicone oil-treated silica particles (RY 200 prepared by Nippon Aerosil Co., Ltd.) are mixed by using a Henschel mixer so as to obtain a toner (1).

Preparation of Developer
Ferrite particle (average particle diameter of 50 Mm): 100 parts
Toluene: 14 parts
Copolymer of styrene and methyl methacrylate (copolymerization ratio of 15/85): 3 parts
Carbon black: 0.2 parts

The above-described components excluding the ferrite particle are dispersed by using a sand mill so as to prepare a dispersion, and the obtained dispersion is put into a vacuum degassing type kneader together with the ferrite particle, and then is dried under reduced pressure with stirring, thereby obtaining a carrier.

Then, 8 parts of toner (1) is mixed to 100 parts of the carrier, so as to obtain a developer (1).

### Example 2

Preparation of Toner Particle

50 parts of crystalline polyester resin dispersion (1), 25 parts of metallic pigment dispersion, and 4 parts of anionic surfactant (Tayca Power, prepared by Tayca Corporation) are put into a round stainless steel flask, 0.1 N of nitric acid is added to the flask, the pH is adjusted to 4.0, and then 0.2 parts of nitric acid aqueous solution having 10% of concentration of polyaluminum chloride is added to the flask. Subsequently, the resultant is dispersed at 30° C. for five minutes by using a homogenizer (ULTRA-TURRAX T50, manufactured by IKA Ltd.).

Subsequently, 400 parts of amorphous polyester resin dispersion, 50 parts of crystalline polyester resin dispersion (1), 175 parts of metallic pigment dispersion, and 70 parts of release agent dispersion are added to the dispersed slurry, 0.1 N of nitric acid is further added thereto, the pH of the mixture is adjusted to be 4.0, then 2.8 parts of nitric acid aqueous solution having 10% of concentration of polyaluminum chloride is added to the mixture, the mixture is dispersed at 30° C. for five minutes by using a homogenizer, and then the resultant is heated up to 45° C. in an oil bath for heating and kept for 30 minutes. After that, 230 parts of amorphous polyester resin dispersion is added to the obtained resultant and kept for one hour, 0.1 N aqueous sodium hydroxide solution is added thereto, the pH is adjusted to be 8.5, and then the resultant is heated up to 73° C. (in the vicinity of the melting temperature of the crystalline resin) while continuously stirring, and kept for five hours. Then, the resultant is cooled down to 20° C. at a rate of 20° C./min, filtrated, sufficiently washed by ion exchange water, and dried, thereby obtaining a toner particle (2) having a volume average particle diameter of 12 μm.

Preparation of Toner and Developer

A toner (2) and a developer (2) are obtained in the same manner as in Example 1 except that the toner particles (2) are used instead of the toner particles (1).

### Example 3

Preparation of Toner Particle

50 parts of crystalline polyester resin dispersion (1), 100 parts of metallic pigment dispersion, and 4 parts of anionic surfactant (Tayca Power, prepared by Tayca Corporation) are put into the round stainless steel flask, 0.1 N of nitric acid is added thereto, the pH is adjusted to be 4.0, and then 0.5 parts of nitric acid aqueous solution having 10% of concentration of polyaluminum chloride is added to the flask. Subsequently, the resultant is dispersed at 30° C. for five minutes by using a homogenizer (ULTRA-TURRAX T50, manufactured by IKA Ltd.).

Subsequently, 400 parts of amorphous polyester resin dispersion, 50 parts of crystalline polyester resin dispersion (1), 100 parts of metallic pigment dispersion, and 70 parts of release agent dispersion are added to the dispersed slurry, 0.1 N of nitric acid is further added thereto, the pH of the mixture is adjusted to be 4.0, then 2.5 parts of nitric acid aqueous solution having 10% of concentration of polyaluminum chloride is added to the mixture, the mixture is dispersed at 30° C. for five minutes by using a homogenizer, and then the resultant is heated up to 45° C. in an oil bath for heating and kept for 30 minutes. After that, 230 parts of amorphous polyester resin dispersion is added to the obtained resultant and kept for one hour, 0.1 N aqueous sodium hydroxide solution is added thereto, the pH is adjusted to be 8.5, and then the resultant is heated up to 73° C. (in the vicinity of the melting temperature of the crystalline resin) while continuously stirring, and kept for five hours. Then, the resultant is cooled down to 20° C. at a rate of 20° C./min, filtrated, sufficiently washed by ion exchange water, and dried, thereby obtaining a toner particle (3) having a volume average particle diameter of 12 μm.

Preparation of Toner and Developer

A toner (3) and a developer (3) are obtained in the same manner as in Example 1 except that the toner particles (3) are used instead of the toner particles (1).

### Example 4

Preparation of Toner Particle

20 parts of crystalline polyester resin dispersion (1) and 20 parts of metallic pigment dispersion, and 4 parts of anionic surfactant (Tayca Power, prepared by Tayca Corporation) are put into a round stainless steel flask, 0.1 N of nitric acid is added to the flask, the pH is adjusted to 4.0, and then 0.2 parts of nitric acid aqueous solution having 10% of concentration of polyaluminum chloride is added to the flask. Subsequently, the resultant is dispersed at 30° C. for five minutes by using a homogenizer (ULTRA-TURRAX T50, manufactured by IKA Ltd.).

Subsequently, 400 parts of amorphous polyester resin dispersion, 80 parts of crystalline polyester resin dispersion (1), 180 parts of metallic pigment dispersion, and 70 parts of release agent dispersion are added to the dispersed slurry, 0.1 N of nitric acid is further added thereto, the pH of the mixture is adjusted to be 4.0, then 2.8 parts of nitric acid aqueous solution having 10% of concentration of polyaluminum chloride is added to the mixture, the mixture is dispersed at 30° C. for five minutes by using a homogenizer, and then the resultant is heated up to 45° C. in an oil bath for heating and kept for 30 minutes. After that, 230 parts of amorphous polyester resin dispersion is added to the obtained resultant and kept for one hour, 0.1 N aqueous sodium hydroxide solution is added thereto, the pH is adjusted to be 8.5, and then the resultant is heated up to 73° C. (in the vicinity of the melting temperature of the crystalline resin) while continuously stirring, and kept for five hours. Then, the resultant is cooled down to 20° C. at a rate of 20° C./min, filtrated, sufficiently washed by ion exchange water, and dried, thereby obtaining a toner particle (4) having a volume average particle diameter of 12 μm.

Preparation of Toner and Developer

A toner (4) and a developer (4) are obtained in the same manner as in Example 1 except that the toner particles (4) are used instead of the toner particles (1).

### Example 5

Preparation of Toner Particle

100 parts of crystalline polyester resin dispersion (1) and 100 parts of metallic pigment dispersion, and 4 parts of anionic surfactant (Tayca Power, prepared by Tayca Corporation) are put into a round stainless steel flask, 0.1 N of nitric acid is added to the flask, the pH is adjusted to 4.0, and then 0.6 parts of nitric acid aqueous solution having 10% of concentration of polyaluminum chloride is added to the flask. Subsequently, the resultant is dispersed at 30° C. for five minutes by using a homogenizer (ULTRA-TURRAX T50, manufactured by IKA Ltd.).

Subsequently, 400 parts of amorphous polyester resin dispersion, 100 parts of metallic pigment dispersion, and 70 parts of release agent dispersion are added to the dispersed slurry, 0.1 N of nitric acid is further added thereto, the pH of the mixture is adjusted to be 4.0, then 2.4 parts of nitric acid aqueous solution having 10% of concentration of polyaluminum chloride is added to the mixture, the mixture is dispersed at 30° C. for five minutes by using a homogenizer, and then the resultant is heated up to 45° C. in an oil bath for heating and kept for 30 minutes. After that, 230 parts of amorphous polyester resin dispersion is added to the obtained resultant and kept for one hour, 0.1 N aqueous sodium hydroxide solution is added thereto, the pH is adjusted to be 8.5, and then the resultant is heated up to 73° C. (in the vicinity of the melting temperature of the crystalline resin) while continuously stirring, and kept for five hours. Then, the resultant is cooled down to 20° C. at a rate of 20° C./min, filtrated, sufficiently washed by ion exchange water, and dried, thereby obtaining a toner particle (5) having a volume average particle diameter of 12 μm.

Preparation of Toner and Developer

A toner (5) and a developer (5) are obtained in the same manner as in Example 1 except that the toner particles (5) are used instead of the toner particles (1).

### Example 6

Preparation of Toner Particle

50 parts of crystalline polyester resin dispersion (1), 150 parts of metal pigment dispersion, and 4 parts of anionic surfactant (Tayca Power, prepared by Tayca Corporation) are put into the round stainless steel flask, 0.1 N of nitric acid is added thereto, the pH is adjusted to be 4.0, and then 0.6 parts of nitric acid aqueous solution having 10% of concentration of polyaluminum chloride is added to the flask. Subsequently, the resultant is dispersed at 30° C. for five minutes by using a homogenizer (ULTRA-TURRAX T50, manufactured by IKA Ltd.).

Subsequently, 400 parts of amorphous polyester resin dispersion, 50 parts of crystalline polyester resin dispersion (1), 50 parts of metallic pigment dispersion, and 70 parts of release agent dispersion are added to the dispersed slurry, 0.1 N of nitric acid is further added thereto, the pH of the mixture is adjusted to be 4.0, then 2.4 parts of nitric acid aqueous solution having 10% of concentration of polyaluminum chloride is added to the mixture, the mixture is dispersed at 30° C. for five minutes by using a homogenizer, and then the resultant is heated up to 45° C. in an oil bath for heating and kept for 30 minutes. After that, 230 parts of amorphous polyester resin dispersion is added to the obtained resultant and kept for one hour, 0.1 N aqueous sodium hydroxide solution is added thereto, the pH is adjusted to be 8.5, and then the resultant is heated up to 73° C. (in the vicinity of the melting temperature of the crystalline resin) while continuously stirring, and kept for five hours. Then, the resultant is cooled down to 20° C. at a rate of 20° C./min, filtrated, sufficiently washed by ion exchange water, and dried, thereby obtaining a toner particle (6) having a volume average particle diameter of 12 μm.

Preparation of Toner and Developer

A toner (6) and a developer (6) are obtained in the same manner as in Example 1 except that the toner particles (6) are used instead of the toner particles (1).

### Example 7

Preparation of Toner Particle

15 parts of crystalline polyester resin dispersion (1), 15 parts of metallic pigment dispersion, and 4 parts of anionic surfactant (Tayca Power, prepared by Tayca Corporation) are put into the round stainless steel flask, 0.1 N of nitric acid is added thereto, the pH is adjusted to be 4.0, and then 0.2 parts of nitric acid aqueous solution having 10% of concentration of polyaluminum chloride is added to the flask. Subsequently, the resultant is dispersed at 30° C. for five minutes by using a homogenizer (ULTRA-TURRAX T50, manufactured by IKA Ltd.).

Subsequently, 400 parts of amorphous polyester resin dispersion, 75 parts of crystalline polyester resin dispersion (1), 175 parts of metallic pigment dispersion, and 70 parts of release agent dispersion are added to the dispersed slurry, 0.1 N of nitric acid is further added thereto, the pH of the mixture is adjusted to be 4.0, then 2.8 parts of nitric acid aqueous solution having 10% of concentration of polyaluminum chloride is added to the mixture, the mixture is dispersed at 30° C. for five minutes by using a homogenizer, and then the resultant is heated up to 45° C. in an oil bath for heating and kept for 30 minutes. After that, 230 parts of amorphous polyester resin dispersion is added to the obtained resultant and kept for one hour, 0.1 N aqueous sodium hydroxide solution is added thereto, the pH is adjusted to be 8.5, and then the resultant is heated up to 73° C. (in the vicinity of the melting temperature of the crystalline resin) while continuously stirring, and kept for five hours. Then, the resultant is cooled down to 20° C. at a rate of 20° C./min, filtrated, sufficiently washed by ion exchange water, and dried, thereby obtaining a toner particle (7) having a volume average particle diameter of 12 μm.

Preparation of Toner and Developer

A toner (7) and a developer (7) are obtained in the same manner as in Example 1 except that the toner particles (7) are used instead of the toner particles (1).

### Example 8

Preparation of Toner Particle

50 parts of crystalline polyester resin dispersion (2), 100 parts of metallic pigment dispersion, and 4 parts of anionic surfactant (Tayca Power, prepared by Tayca Corporation) are put into the round stainless steel flask, 0.1 N of nitric acid is added thereto, the pH is adjusted to be 4.0, and then 0.5 parts of nitric acid aqueous solution having 10% of concentration of polyaluminum chloride is added to the flask. Subsequently, the resultant is dispersed at 30° C. for five minutes by using a homogenizer (ULTRA-TURRAX T50, manufactured by IKA Ltd.).

Subsequently, 400 parts of amorphous polyester resin dispersion, 50 parts of crystalline polyester resin dispersion (2), 100 parts of metallic pigment dispersion, and 70 parts of release agent dispersion are added to the dispersed slurry, 0.1 N of nitric acid is further added thereto, the pH of the mixture is adjusted to be 4.0, then 2.5 parts of nitric acid aqueous solution having 10% of concentration of polyaluminum chloride is added to the mixture, the mixture is dispersed at 30° C. for five minutes by using a homogenizer, and then the resultant is heated up to 45° C. in an oil bath for heating and kept for 30 minutes. After that, 230 parts of amorphous polyester resin dispersion is added to the obtained resultant and kept for one hour, 0.1 N aqueous sodium hydroxide solution is added thereto, the pH is adjusted to be 8.5, and then the resultant is heated up to 60° C. (in the vicinity of the melting temperature of the crystalline resin) while continuously stirring, and kept for eight hours. Then, the resultant is cooled down to 20° C. at a rate of 20° C./min, filtrated, sufficiently washed by ion exchange water, and dried, thereby obtaining a toner particle (8) having a volume average particle diameter of 12 μm.

Preparation of Toner and Developer

A toner (8) and a developer (8) are obtained in the same manner as in Example 1 except that the toner particles (8) are used instead of the toner particles (1).

### Example 9

Preparation of Toner Particle

50 parts of crystalline polyester resin dispersion (3), 100 parts of metal pigment dispersion, and 4 parts of anionic surfactant (Tayca Power, prepared by Tayca Corporation) are put into a round stainless steel flask, 0.1 N of nitric acid is added to the flask, the pH is adjusted to 4.0, and then 0.3 parts of nitric acid aqueous solution having 10% of concentration of polyaluminum chloride is added to the flask. Subsequently, the resultant is dispersed at 30° C. for five minutes by using a homogenizer (ULTRA-TURRAX T50, manufactured by IKA Ltd.).

Subsequently, 400 parts of amorphous polyester resin dispersion, 50 parts of crystalline polyester resin dispersion (3), 100 parts of metallic pigment dispersion, and 70 parts of release agent dispersion are added to the dispersed slurry, 0.1 N of nitric acid is further added thereto, the pH of the mixture is adjusted to be 4.0, then 2.7 parts of nitric acid aqueous solution having 10% of concentration of polyaluminum chloride is added to the mixture, the mixture is dispersed at 30° C. for five minutes by using a homogenizer, and then the resultant is heated up to 45° C. in an oil bath for heating and kept for 30 minutes. After that, 230 parts of amorphous polyester resin dispersion is added to the obtained resultant and kept for one hour, 0.1 N aqueous sodium hydroxide solution is added thereto, the pH is adjusted to be 8.5, and then the resultant is heated up to 85° C. (in the vicinity of the melting temperature of the crystalline resin) while continuously stirring, and kept for three hours. Then, the resultant is cooled down to 20° C. at a rate of 20° C./min, filtrated, sufficiently washed by ion exchange water, and dried, thereby obtaining a toner particle (9) having a volume average particle diameter of 12 μm.

Preparation of Toner and Developer

A toner (9) and a developer (9) are obtained in the same manner as in Example 1 except that the toner particles (9) are used instead of the toner particles (1).

### Example 10

Preparation of Toner Particle

25 parts of crystalline styrene acrylic resin dispersion, 50 parts of metallic pigment dispersion, and 4 parts of anionic surfactant (Tayca Power, prepared by Tayca Corporation) are put into a round stainless steel flask, 0.1 N of nitric acid is added to the flask, the pH is adjusted to 4.0, and then 0.3 parts of nitric acid aqueous solution having 10% of concentration of polyaluminum chloride is added to the flask. Subsequently, the resultant is dispersed at 30° C. for five minutes by using a homogenizer (ULTRA-TURRAX T50, manufactured by IKA Ltd.).

Subsequently, 200 parts of amorphous styrene acrylic resin dispersion, 25 parts of crystalline styrene acrylic resin dispersion, 150 parts of metallic pigment dispersion, and 70 parts of release agent dispersion are added to the dispersed slurry, 0.1 N of nitric acid is further added thereto, the pH of the mixture is adjusted to be 4.0, then 2.7 parts of nitric acid aqueous solution having 10% of concentration of polyaluminum chloride is added to the mixture, the mixture is dispersed at 30° C. for five minutes by using a homogenizer, and then the resultant is heated up to 45° C. in an oil bath for heating and kept for 30 minutes. After that, 115 parts of amorphous styrene acrylic resin dispersion is added to the obtained resultant and kept for one hour, 0.1 N aqueous sodium hydroxide solution is added thereto, the pH is adjusted to be 6.0, and then the resultant is heated up to 65° C. (in the vicinity of the melting temperature of the crystalline resin) while continuously stirring, and kept for five hours. Then, the resultant is cooled down to 20° C. at a rate of 20° C./min, filtrated, sufficiently washed by ion exchange water, and dried, thereby obtaining a toner particle (10) having a volume average particle diameter of 12 μm.

Preparation of Toner and Developer

A toner (10) and a developer (10) are obtained in the same manner as in Example 1 except that the toner particles (10) are used instead of the toner particles (1).

### Example 11

Preparation of Toner Particle

50 parts of crystalline polyester resin dispersion (1) and 50 parts of titanium white pigment dispersion, and 4 parts of anionic surfactant (Tayca Power, prepared by Tayca Corporation) are put into a round stainless steel flask, 0.1 N of nitric acid is added to the flask, the pH is adjusted to 4.0, and then 0.3 parts of nitric acid aqueous solution having 10% of concentration of polyaluminum chloride is added to the flask. Subsequently, the resultant is dispersed at 30° C. for five minutes by using a homogenizer (ULTRA-TURRAX T50, manufactured by IKA Ltd.).

Subsequently, 400 parts of amorphous polyester resin dispersion, 50 parts of crystalline polyester resin dispersion (1), 150 parts of titanium white pigment dispersion, and 70 parts of release agent dispersion are added to the dispersed slurry, 0.1 N of nitric acid is further added thereto, the pH of the mixture is adjusted to be 4.0, then 2.7 parts of nitric acid aqueous solution having 10% of concentration of polyaluminum chloride is added to the mixture, the mixture is dispersed at 30° C. for five minutes by using a homogenizer, and then the resultant is heated up to 45° C. in an oil bath for heating and kept for 30 minutes. After that, 230 parts of amorphous polyester resin dispersion is added to the obtained resultant and kept for one hour, 0.1 N aqueous sodium hydroxide solution is added thereto, the pH is adjusted to be 8.5, and then the resultant is heated up to 73° C. (in the vicinity of the melting temperature of the crystalline resin) while continuously stirring, and kept for five hours. Then, the resultant is cooled down to 20° C. at a rate of 20° C./min, filtrated, sufficiently washed by ion exchange water, and dried, thereby obtaining a toner particle (11) having a volume average particle diameter of 7.5 μm.

Preparation of Toner and Developer

A toner (11) and a developer (11) are obtained in the same manner as in Example 1 except that the toner particles (11) are used instead of the toner particles (1).

### Example 12

Preparation of Toner Particle

50 parts of crystalline polyester resin dispersion (1) and 50 parts of lead white pigment dispersion, and 4 parts of anionic surfactant (Tayca Power, prepared by Tayca Corporation) are put into a round stainless steel flask, 0.1 N of nitric acid is added to the flask, the pH is adjusted to 4.0, and then 0.3 parts of nitric acid aqueous solution having 10% of concentration of polyaluminum chloride is added to the flask. Subsequently, the resultant is dispersed at 30° C. for five minutes by using a homogenizer (ULTRA-TURRAX T50, manufactured by IKA Ltd.).

Subsequently, 400 parts of amorphous polyester resin dispersion, 50 parts of crystalline polyester resin dispersion (1), 150 parts of lead white pigment dispersion, and 70 parts of release agent dispersion are added to the dispersed slurry, 0.1 N of nitric acid is further added thereto, the pH of the mixture is adjusted to be 4.0, then 2.7 parts of nitric acid aqueous solution having 10% of concentration of polyaluminum chloride is added to the mixture, the mixture is dispersed at 30° C. for five minutes by using a homogenizer, and then the resultant is heated up to 45° C. in an oil bath for heating and kept for 30 minutes. After that, 230 parts of amorphous polyester resin dispersion is added to the obtained resultant and kept for one hour, 0.1 N aqueous sodium hydroxide solution is added thereto, the pH is adjusted to be 8.5, and then the resultant is heated up to 73° C. (in the vicinity of the melting temperature of the crystalline resin) while continuously stirring, and kept for five hours. Then, the resultant is cooled down to 20° C. at a rate of 20° C./min, filtrated, sufficiently washed by ion exchange water, and dried, thereby obtaining a toner particle (12) having a volume average particle diameter of 7.5 μm.

Preparation of Toner and Developer

A toner (12) and a developer (12) are obtained in the same manner as in Example 1 except that the toner particles (12) are used instead of the toner particles (1).

### Example 13

Preparation of Toner Particle

50 parts of crystalline polyester resin dispersion (1) and 50 parts of cobalt blue pigment dispersion, and 4 parts of anionic surfactant (Tayca Power, prepared by Tayca Corporation) are put into a round stainless steel flask, 0.1 N of nitric acid is added to the flask, the pH is adjusted to 4.0, and then 0.3 parts of nitric acid aqueous solution having 10% of concentration of polyaluminum chloride is added to the flask. Subsequently, the resultant is dispersed at 30° C. for five minutes by using a homogenizer (ULTRA-TURRAX T50, manufactured by IKA Ltd.).

Subsequently, 400 parts of amorphous polyester resin dispersion, 50 parts of crystalline polyester resin dispersion (1), 150 parts of cobalt blue pigment dispersion, and 70 parts of release agent dispersion are added to the dispersed slurry, 0.1 N of nitric acid is further added thereto, the pH of the mixture is adjusted to be 4.0, then 2.7 parts of nitric acid aqueous solution having 10% of concentration of polyaluminum chloride is added to the mixture, the mixture is dispersed at 30° C. for five minutes by using a homogenizer, and then the resultant is heated up to 45° C. in an oil bath for heating and kept for 30 minutes. After that, 230 parts of amorphous polyester resin dispersion is added to the obtained resultant and kept for one hour, 0.1 N aqueous sodium hydroxide solution is added thereto, the pH is adjusted to be 8.5, and then the resultant is heated up to 73° C. (in the vicinity of the melting temperature of the crystalline resin) while continuously stirring, and kept for five hours. Then, the resultant is cooled down to 20° C. at a rate of 120° C./min, filtrated, sufficiently washed by ion exchange water, and dried, thereby obtaining a toner particle (13) having a volume average particle diameter of 7.5 μm.

Preparation of Toner and Developer

A toner (13) and a developer (13) are obtained in the same manner as in Example 1 except that the toner particles (13) are used instead of the toner particles (1).

### Example 14

Preparation of Toner Particle

50 parts of crystalline polyester resin dispersion (2) and 50 parts of metallic pigment dispersion, and 4 parts of anionic surfactant (Tayca Power, prepared by Tayca Corporation) are put into a round stainless steel flask, 0.1 N of nitric acid is added to the flask, the pH is adjusted to 4.0, and then 0.3 parts of nitric acid aqueous solution having 10% of concentration of polyaluminum chloride is added to the flask. Subsequently, the resultant is dispersed at 30° C. for five minutes by using a homogenizer (ULTRA-TURRAX T50, manufactured by IKA Ltd.).

Subsequently, 400 parts of amorphous polyester resin dispersion, 50 parts of crystalline polyester resin dispersion (2), 150 parts of metallic pigment dispersion, and 70 parts of release agent dispersion are added to the dispersed slurry, 0.1 N of nitric acid is further added thereto, the pH of the mixture is adjusted to be 4.0, then 2.7 parts of nitric acid aqueous solution having 10% of concentration of polyaluminum chloride is added to the mixture, the mixture is dispersed at 30° C. for five minutes by using a homogenizer, and then the resultant is heated up to 45° C. in an oil bath for heating and kept for 30 minutes. After that, 230 parts of amorphous polyester resin dispersion is added to the obtained resultant and kept for one hour, 0.1 N aqueous sodium hydroxide solution is added thereto, the pH is adjusted to be 8.5, and then the resultant is heated up to 60° C. (in the vicinity of the melting temperature of the crystalline resin) while continuously stirring, and kept for eight hours. Then, the resultant is cooled down to 20° C. at a rate of 20° C./min, filtrated, sufficiently washed by ion exchange water, and dried, thereby obtaining a toner particle (14) having a volume average particle diameter of 12 μm.

Preparation of Toner and Developer

A toner (14) and a developer (14) are obtained in the same manner as in Example 1 except that the toner particles (14) are used instead of the toner particles (1).

### Comparative Example 1

Preparation of Toner Particle

50 parts of amorphous polyester resin dispersion and 50 parts of metallic pigment dispersion, and 4 parts of anionic surfactant (Tayca Power, prepared by Tayca Corporation) are put into a round stainless steel flask, 0.1 N of nitric acid is added to the flask, the pH is adjusted to 4.0, and then 0.3 parts of nitric acid aqueous solution having 10% of concentration of polyaluminum chloride is added to the flask. Subsequently, the resultant is dispersed at 30° C. for five minutes by using a homogenizer (ULTRA-TURRAX T50, manufactured by IKA Ltd.).

Subsequently, 450 parts of amorphous polyester resin dispersion, 150 parts of metallic pigment dispersion, and 70 parts of release agent dispersion are added to the dispersed slurry, 0.1 N of nitric acid is further added thereto, the pH of the mixture is adjusted to be 4.0, then 2.7 parts of nitric acid aqueous solution having 10% of concentration of polyaluminum chloride is added to the mixture, the mixture is dispersed at 30° C. for five minutes by using a homogenizer, and then the resultant is heated up to 45° C. in an oil bath for heating and kept for 30 minutes. After that, 230 parts of amorphous polyester resin dispersion is added to the obtained resultant and kept for one hour, 0.1 N aqueous sodium hydroxide solution is added thereto, the pH is adjusted to be 8.5, and then the resultant is heated up to 75° C. while continuously stirring, and kept for five hours. Then, the resultant is cooled down to 20° C. at a rate of 20° C./min, filtrated, sufficiently washed by ion exchange water, and dried, thereby obtaining a toner particle (C1) having a volume average particle diameter of 12 μm.

Preparation of Toner and Developer

A toner (C1) and a developer (C1) are obtained in the same manner as in Example 1 except that the toner particles (C1) are used instead of the toner particles (1).

### Reference Example 1

Preparation of Toner Particle
Amorphous polyester resin dispersion: 400 parts
Crystalline polyester resin dispersion (1): 100 parts
Cyan coloring agent dispersion: 200 parts
Release agent particle dispersion: 70 parts
Anionic surfactant (Tayca Power, prepared by Tayca Corporation): 4 parts

The above-described materials are put into the round stainless steel flask, 0.1 N of nitric acid is further added thereto, the pH of the mixture is adjusted to be 4.0, then 3.0 parts of nitric acid aqueous solution having 10% of concentration of polyaluminum chloride is added to the mixture. Subsequently, the mixture is dispersed at 30° C. for five minutes by using a homogenizer (ULTRA-TURRAX T50, manufactured by IKA Ltd.), and then the resultant is heated up to 45° C. in an oil bath for heating and kept for 30 minutes. After that, 230 parts of amorphous polyester resin dispersion is added to the obtained resultant and kept for one hour, 0.1 N aqueous sodium hydroxide solution is added thereto, the pH is adjusted to be 8.5, and then the resultant is heated up to 73° C. (in the vicinity of the melting temperature of the crystalline resin) while continuously stirring, and kept for five hours. Then, the resultant is cooled down to 20° C. at a rate of 20° C./min, filtrated, sufficiently washed by ion exchange water, and dried, thereby obtaining a toner particle (R1) having a volume average particle diameter of 7.5 μm.

Preparation of Toner and Developer

A toner (R1) and a developer (R1) are obtained in the same manner as in Example 1 except that the toner particles (R1) are used instead of the toner particles (1).

### Reference Example 2

Preparation of Toner Particle

Method of Preparing Crystalline Polyester Resin

After 98 mol % of dimethyl sebacate, 2 mol % of sodium dimethyl isophthalate-5-sulfonate, 100 mol % of ethylene glycol, and 0.3 parts of dibutyl tin oxide as a catalyst with respect to 100 parts of monomer component are put into a heat-dried three-necked flask, air in the container is changed to an inert atmosphere with nitrogen gas by a pressure reduction operation, and stirring and refluxing are performed with mechanical stirring at 180° C. for five hours. Thereafter, the temperature is slowly raised up to 230° C. under the reduced pressure, and the mixture is stirred for two hours. When the mixture becomes viscous, it is cooled with air, the reaction is stopped, and then drying is performed so as to synthesize a crystalline polyester resin. From the molecular weight measurement (in terms of polystyrene) performed by gel permeation chromatography, the crystalline polyester resin has glass transition temperature (Tg) of 64° C., the weight average molecular weight (Mn) of 4,600, and the number average molecular weight (Mw) of 9,700.
Crystalline polyester resin: 20 parts
Amorphous polyester resin: 42 parts (terephthalic acid/Bisphenol A ethylene oxide adduct/linear polyester by condensation polymerization of cyclohexane dimethanol, Tg=62° C., Mn=4,000, Mw=12,000)
Titanium oxide (CR60: prepared by Ishihara Sangyo Kaisha, Ltd.): 30 parts
Paraffin wax HNP9 (melting point 75° C.: prepared by Nippon Seiro, Co., Ltd.): 8 parts

The above-described components are thoroughly premixed with each other by a HENSCHEL mixer, molten-kneaded by a biaxial roll mill, finely pulverized by a jet mill after cooling, and then classified twice by a wind classifier so as to obtain a toner particle (R2) having a volume average particle diameter of 7.0 μm and a coloring agent concentration of 30%.

Preparation of Toner and Developer

A toner (R2) and a developer (R2) are obtained in the same manner as in Example 1 except that the toner particles (R2) are used instead of the toner particles (1).

Evaluation
Low-temperature fixability test

The developing device of a color copying machine, Docucentre Color 400 (manufactured by Fuji Xerox Co., Ltd.) from which the fixing device is removed is filled with obtained developer, and is adjusted such that a toner applied amount becomes 0.50 mg/cm² so as to output an unfixed image. A4 sized-JD paper (basis weight 157 gsm) manufactured by Fuji Xerox Co., Ltd. is used as a recording medium. The output image is an image having a size of 50 mm×50 mm with an image density of 100′%.

As an apparatus for fixing evaluation, an apparatus in which a fixing device of APEOS PORT IV C3370 manufactured by Fuji Xerox Co., Ltd. is removed and is modified such that the fixing temperature may be changed is used. The process rate is 175 mm/sec.

Under the aforementioned conditions, the unfixed image is fixed by changing the temperature of the fixing device by 5° C. from 110° C. to 200° C. so as to obtain a fixed image. The fixed image portion is bent by using a weight, and the lowest fixing temperature is evaluated based on the image deficiency degree of the bent portion. The obtained results are indicated in Table 1.

Stacking Test

DOCUCENTRE COLOR 400 manufactured by Fuji Xerox Co., Ltd. is used as a sample preparation device for evaluation. The developing device is filled with the obtained developer, A4 sized-JD paper (basis weight: 157 gsm) manufactured by Fuji Xerox Co., Ltd. is used as a recording medium, and 500 sheets of printing paper are continuously output to the same discharge tray with a high image density (density 100% and toner applied amount of 120 g/m²) under the environment of 25° C. and 50 RH %, and are kept for one hour in a stacked state.

Subsequently, the image defects of the fixed image of the 51st sheet of the print paper, which is most likely to cause image defects in terms of latent heat amount and pressure, are evaluated. The obtained results are indicated in Table 1.

Note that, in the image defect evaluation, the ratio of areas of the exposed paper in which the image is peeled off due to the fusion between images is evaluated.

Evaluation Criteria

G1: The image deficiency rate is less than 0.50% and it is difficult to visually discriminate.

G2: The image deficiency rate is equal to or greater than 0.50% and less than 1.0%, which is minor and within tolerance.

G3: Due to fusion between images, the image deficiency rate is equal to or greater than 1.0, which is out of tolerance.

TABLE 1

| | Tm | | Difference between | | | Ratio of absolute value of | Low temperature | Stacking |
|---|---|---|---|---|---|---|---|---|
| | (° C.) | Tc (° C.) | Tm and Tc (° C.) | Qm (J/g) | Qc (J/g) | Qm to absolute value of Qc | fixability (° C.) | properties |
| Example 1 | 74 | 63 | 10 | 13.4 | 6.8 | 51 | 120 | G1 |
| Example 2 | 74 | 71 | 2 | 13.6 | 6.8 | 50 | 120 | G2 |
| Example 3 | 74 | 53 | 20 | 13.8 | 7.3 | 53 | 120 | G1 |
| Example 4 | 74 | 63 | 10 | 13.5 | 2.9 | 22 | 120 | G1 |
| Example 5 | 74 | 63 | 10 | 13.5 | 11.8 | 87 | 120 | G1 |
| Example 6 | 74 | 49 | 24 | 13.8 | 7.1 | 51 | 120 | G2 |
| Example 7 | 74 | 62 | 11 | 13.6 | 2.4 | 18 | 120 | G2 |
| Example 8 | 55 | 35 | 20 | 11.5 | 6.3 | 55 | 110 | G2 |
| Example 9 | 91 | 71 | 20 | 15.3 | 7.4 | 48 | 130 | G1 |
| Example 10 | 62 | 55 | 7 | 10.5 | 5.1 | 49 | 110 | G1 |
| Example 11 | 74 | 63 | 10 | 13.5 | 6.7 | 50 | 120 | G1 |
| Example 12 | 74 | 63 | 10 | 13.6 | 6.7 | 49 | 120 | G1 |
| Example 13 | 74 | 63 | 10 | 13.5 | 6.6 | 49 | 120 | G1 |
| Example 14 | 55 | 44 | 11 | 11.6 | 6.3 | 50 | 110 | G1 |
| Comparative Example 1 | — | — | — | — | — | — | 150 | G3 |
| Reference Example 1 | 74 | — | — | 13.6 | — | — | 120 | G3 |
| Reference Example 2 | 64 | — | — | 12.3 | — | — | 120 | G3 |

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An electrostatic charge image developing toner comprising:
a toner particle which contains a crystalline resin, an amorphous resin, and at least one of an inorganic pigment and a metallic pigment,
wherein, in differential scanning calorimetry, an endothermic peak Tm (° C.) derived from the crystalline resin in a first temperature rising process and an exothermic peak Tc (° C.) derived from the crystalline resin in a first temperature falling process after the first temperature rising process are present, and a relationship expressed by Tm>Tc is satisfied.

2. The electrostatic charge image developing toner according to claim 1,
wherein a difference between the endothermic peak Tm and the exothermic peak Tc is from 2° C. to 20° C.

3. The electrostatic charge image developing toner according to claim 1,
wherein an absolute value Qm of an endothermic quantity of the endothermic peak Tm and an absolute value Qc of an exothermic quantity of the exothermic peak Tc satisfy a relationship expressed by Qm>Qc.

4. The electrostatic charge image developing toner according to claim 3,
wherein, when the absolute value Qm of the endothermic quantity is taken as 100, a ratio of the absolute value Qc of the exothermic quantity is from 20 to 90.

5. The electrostatic charge image developing toner according to claim 1,
wherein the exothermic peak Tc is from 40° C. to 70° C.

6. The electrostatic charge image developing toner according to claim 1,
wherein the inorganic pigment contains a titanium oxide particle.

7. The electrostatic charge image developing toner according to claim 1,
wherein the metallic pigment contains an aluminum particle.

8. An electrostatic charge image developer comprising:
the electrostatic charge image developing toner according to claim 1.

9. A toner cartridge comprising:
a container that contains the electrostatic charge image developing toner according to claim 1,
wherein the toner cartridge is detachable from an image forming apparatus.
